(19) United States
(12) Patent Application Publication
(10) Pub. No.: US 2013/0198606 A1
(43) Pub. Date: Aug. 1, 2013

(54) SOFTWARE APPLICATION DISTRIBUTION IN DOCUMENTS

(71) Applicants: Terry Farrell, Dublin (IE); David Mowatt, Dublin (IE); Russell Spencer Alexander Palmer, Seattle, WA (US); David Ahs, Dublin (IE); Brian Michael Jones, Redmond, WA (US); Patrick Michael Conlan, Seattle, WA (US); Rolando Jimenez-Salgado, Redmond, WA (US); Maurizio Cibelli, Dublin (IE)

(72) Inventors: Terry Farrell, Dublin (IE); David Mowatt, Dublin (IE); Russell Spencer Alexander Palmer, Seattle, WA (US); David Ahs, Dublin (IE); Brian Michael Jones, Redmond, WA (US); Patrick Michael Conlan, Seattle, WA (US); Rolando Jimenez-Salgado, Redmond, WA (US); Maurizio Cibelli, Dublin (IE)

(73) Assignee: Microsoft Corporation, Redmond, WA (US)

(21) Appl. No.: 13/360,809

(22) Filed: Jan. 30, 2012

(51) Int. Cl. G06F 17/00; G06F 15/16

(52) U.S. Cl. 715/234

(57) ABSTRACT

Concepts and technologies are described herein for distributing web-based software application extensions within documents. In accordance with some of the concepts and technologies disclosed herein, users that own web-based software application extensions or have trial access to web-based software application extensions can add them to documents. The users can then distribute the documents containing the web-based software application extensions to other users, who may or may not be licensed to use the web-based software application extensions. The documents can be distributed in any way that files are distributed. When a user receives a document containing a web-based software application extensions, the user can obtain trial rights to the web-based software application extensions or purchase the web-based software application extensions from without having to visit a virtual marketplace.

### BACKGROUND

In recent years, the software industry has begun to undergo a shift from the distribution of software applications on physical media, such as CD and DVD, to the distribution of software applications through services that facilitate the download of software from the Internet. Software download services are typically accessed through a Web-based marketplace and/or through a stand-alone marketplace application installed on an end user's computer or other computing device, such as a smart phone. These marketplaces often organize available applications according to category, provide search functionality, and some provide the option to download trial versions of applications.

Marketplace ecosystems provide developers with an easy way to distribute their applications, keep their applications up-to-date, and to potentially reach millions of end users. These benefits come at the expense of limited distribution within the marketplace or through links to applications within the marketplace. While developers can provide direct download links on their websites or elsewhere on the Internet, this distribution strategy does not have the benefits of the marketplace approach, in particular, the high volume of day-to-day traffic experienced by a marketplace.

It is with respect to these and other considerations that the disclosure made herein is presented.

### SUMMARY

Concepts and technologies are described herein for distributing web-based software application extensions within documents. In accordance with the concepts and technologies disclosed herein, users that own web-based software application extensions, have trial access to, or have free access to web-based software application extensions can add them to documents. The users can then distribute the documents containing the web-based software application extensions to other users, who may or may not be licensed to use the web-based software application extensions. The documents can be distributed in any way that files are distributed. When a user receives a document containing a web-based software application extensions, the user can obtain trial rights to the web-based software application extensions or purchase the web-based software application extensions from without having to visit a virtual marketplace.

According to one aspect, a method for distributing a software application extension with a document includes acquiring the software application extension, creating a document containing the software application extension in a certain state, the certain state being identified in the document as configuration data, saving the document containing the software application extension, and distributing the document to one or more computer systems. One or more of the computer systems may then re-distribute the software application extension in the document to other devices.

According to another aspect, a method for distributing a web add-in includes acquiring the web add-in, creating a document, inserting the web add-in into the document with configuration data identifying a certain state of the web add-in in the document, and saving the document containing a manifest file or a reference to a manifest file describing a location of a web add-in server, which is configured to provide web content for the web add-in, and a static snapshot of the web add-in that permits the web add-in to be viewed a user devices that are configured with a viewer application that facilitates viewing of web add-ins but not editing of web add-ins. The method also includes distributing the document containing the web add-in to one or more user devices.

According to yet another aspect, a method for distributing a web-based software application extension includes acquiring a web add-in distributed by a user device and determining if a user has an entitlement for the web add-in. The method further includes, in response to determining that the user has an entitlement for the web add-in, providing the web add-in for use in accordance with the entitlement. The method further includes, in response to determining that the user does not have an entitlement for the web add-in, presenting options for the user to try or buy the web add-in. The method further includes, in response to acquiring a selection of one of the options, sending an entitlement request to a marketplace server computer, acquiring an entitlement response from the marketplace server computer indicating entitlement terms for an entitlement for the web add-in in accordance with the selected option, and providing the web add-in for use in accordance with the entitlement. The method further includes creating a document, inserting the web add-in into the document, saving the document containing the web add-in, and distributing the document containing the web add-in to one or more other user devices.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an illustrative operating environment for implementing various embodiments presented herein.

FIG. 2 is a diagram illustrating another illustrative operating environment for implementing various embodiments presented herein.

FIGS. 3-6 are flow diagrams illustrating aspects of various methods for distributing web add-ins within documents, according to illustrative embodiments.

FIGS. 7A-7H are user interface diagrams illustrating aspects of adding web add-ins and obtaining entitlements for web add-ins within an application user interface, according to illustrative embodiments.

FIGS. 8A and 8B are flow diagrams illustrating aspects of a method for upgrading a legacy application, according to an illustrative embodiment.

FIGS. 9A-9J are user interface diagram illustrating aspects of upgrading a legacy application, according to illustrative embodiments.

FIG. 10 is a diagram illustrating a tablet device configured to display various user interfaces described herein for use in touch-based interaction with web add-ins, according to an illustrative embodiment.

FIG. 11 is a computer architecture diagram illustrating illustrative computer hardware and software architecture for a computing system capable of implementing aspects of the embodiments presented herein.

FIG. 12 is a diagram illustrating a distributed computing environment capable of implementing aspects of the embodiments presented herein.

FIG. 13 is a computer architecture diagram illustrating a computing device architecture capable of implementing aspects of the embodiments presented herein.

### DETAILED DESCRIPTION

The following detailed description is directed to concepts and technologies for distributing web-based software application extensions within documents. These web-based software application extensions provide a new extensibility model for productivity applications such as those included in productivity application suites like MICROSOFT OFFICE, available from Microsoft Corporation of Redmond, Wash. This new extensibility model allows a broad audience of web application developers to easily create web-based solutions that extend the functionality of productivity applications with web content. Although the following detailed description focuses on extending the functionality of productivity applications, the web-based software application extensions can be used to extend the functionality of other applications, such as multimedia applications, photography applications, design applications, video game applications, and others.

The web-based software application extensions are generally referred to herein as “web add-ins.” A web add-in provides a region containing a web page within an application. The web add-in provides new and interactive content types and functionality. Like web pages, web add-ins can be built using standard web technologies such as, but not limited to, hypertext markup language (“HTML”), Javascript, representational state transfer (“REST”). In contrast with existing extensibility technologies like add-ins and visual basic for applications (“VBA”), web add-ins enable a single codebase to run on multiple environments, including rich client applications, mobile phone applications, tablet applications, and applications configured to run on various personal computer (“PC”) operating systems, such as MICROSOFT WINDOWS, available from Microsoft Corporation of Redmond, Wash., and APPLE MAC OS, available from Apple Inc. of Cupertino, Calif. Web add-ins can be acquired by end users from a virtual marketplace or from collaboration platform websites, such as websites developed using MICROSOFT SHAREPOINT, available from Microsoft Corporation of Redmond, Wash., in the form of stand-alone extensions or subcomponents of document template solutions or applications.

Web add-ins can be configured to do or provide anything a web page can do or provide. For instance, web add-ins can provide an interactive user interface (“UI”), custom logic through dynamic HTML (“DHTML”) and/or Javascript, leverage Javascript frameworks like JQuery, connect to REST/Web services via HTTP/AJAX, and/or host controls provided in ADOBE FLASH, available from Adobe Systems of San Jose, Calif., MICROSOFT SILVERLIGHT, available from Microsoft Corporation of Redmond, Wash., or other application frameworks for developing rich web-based applications and content. In addition to providing the functionality of a web page within a document, web add-ins can interact with a hosting application through a Javascript library that provides application programming interfaces (“APIs”) for reading and writing to documents as well as handling key application and user events like selection change.

In some embodiments, a web add-in includes a reference to and a description of a web server that is capable of providing a web page and/or web service. The reference to and description of the web server is referred to herein as a web add-in manifest, or simply a manifest. The web page and/or web service can be added to a document or an application through a web add-in, as will be described in greater detail herein below.

A virtual marketplace is provided that facilitates users to browse, search, and choose from available manifests. One or more web servers are also provided for powering web add-ins. In some embodiments, the web servers are hosts to download files, such as HTML and/or Javascript files). In some embodiments, the web servers provide a set of web services that connect to a rich back-end that includes server-side logic.

For ease of illustration and description, a web add-in is used herein, at times, to collectively refer to a manifest and the ability for a web server to provide one or more of the following: (1) one or more HTML files; (2) one or more Javascript files; and (3) one or more web services to access server-side functionality and content that add value to a document or application. Alternatively, a web add-in may refer to a manifest and the ability for a web server to provide one or more files based upon any other web technology or any combination of web technologies and one or more web services to access server-side functionality and content that add value to a document or application.

In some embodiments disclosed herein, web add-ins are embedded in documents such as word processing documents, spreadsheet documents, presentation documents, email, and the like. In these embodiments, the web add-ins are referred to as content web add-ins. Content web add-ins enable web pages or portions thereof to become part of a document as embedded content that can be shown inline, wrapped, over, or behind the contents of the document. Content web add-ins can enable embedded media scenarios like video players and picture galleries as part of the document, as well as general external content capabilities.

In some embodiments disclosed herein, web add-ins provide the ability to surface web content on a bigger canvas, thus enabling rich dashboard and process context scenarios. In these embodiments, the web add-ins are referred to as backstage web add-ins.

In some embodiments disclosed herein, web add-ins provide web content within a task pane. A task pane, in some embodiments, is used herein to describe a dockable dialog window within an application user interface. A task pane web add-in allows scenarios where users benefit from seeing supplemental information to the document on which they are currently working, which enhances their ability to perform work. This information may relate to data in a document, such as additional contact information related to a business customer, or may provide extra guidance, such as via a dictionary or encyclopedia. Task pane web add-ins can also extend application capabilities by allowing users to perform actions and submit entries to other systems and services, thereby reducing the need for multiple application contexts and improving the use and benefit of an application or application suite.

In some embodiments disclosed herein, web add-ins allow a user to select a portion of a document (e.g., a cell within a spreadsheet or a sentence in a word processing document) and, through a contextual menu, get access to one or more web add-ins that can provide information or functionality based upon the selection. In these embodiments, the web add-ins are referred to as floating web add-ins. Floating web add-ins can be transient. In other words, floating web add-ins can disappear after a user clicks or otherwise interacts with the document.

Floating web add-ins and task pane add-ins are referred to herein as out-of-document web add-ins. Other types of out-of-document web add-ins include ribbon web add-ins, menu web add-ins, toolbar add-ins, status bar add-ins, popup menu add-ins, or separate applications.

In some embodiments, users that own web add-ins or have trial access to web add-ins can insert them to documents. In some embodiments, any user can insert a web add-in, but may be forced to have some form of advertising appear when using the web add-in. In some embodiments, users are able to insert a web add-in for use in a degraded manner. For instance, a user may be able to insert watermarked images only, or may be able to invoke functionality to perform calculations on limited data sets. Trials in this instance could be used to provide a time-limited free way to access full functionality of a web add-in. In some embodiments, web add-ins are offered free of charge. In any case, the users can then distribute the documents containing the web add-ins to other users, who may or may not be licensed, if applicable, to use the web add-ins. The documents can be distributed in any way that files are distributed. When a user receives a document containing a web add-in, the user can obtain trial rights to the web add-in or purchase the web add-in without having to visit a virtual marketplace.

In some embodiments disclosed herein, web add-ins are contextual. In these embodiments, the web add-in is configured to automatically appear based upon the content included in a document or email.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for distributing web-based software application extensions within documents will be presented.

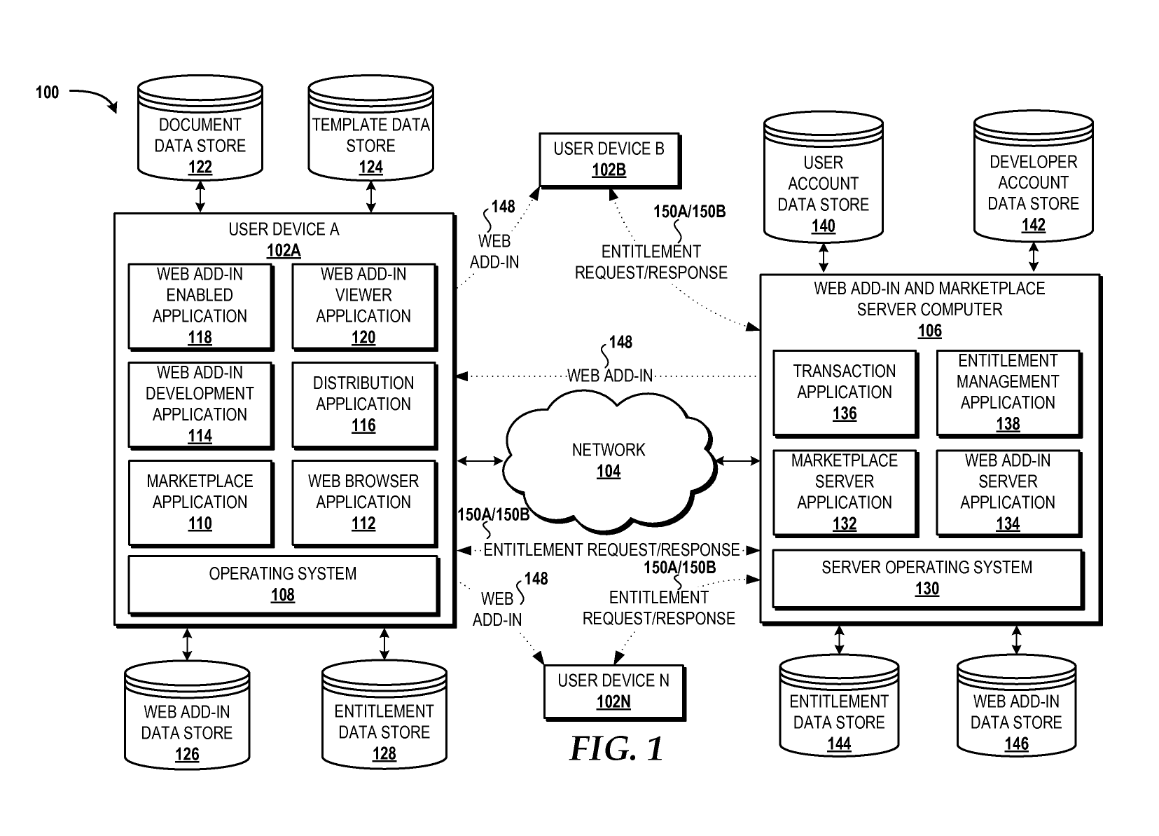

Referring now to FIG. 1, aspects of one operating environment 100 for various embodiments presented herein will be described. The operating environment 100 shown in FIG. 1 includes a user device A 102A operating on or in communication with a network 104. The user device A 102A may be a personal computer (“PC”), desktop workstation, laptop computer, tablet computer, notebook computer, personal digital assistant (“PDA”), electronic-book reader, game console, set-top box, consumer electronics device, server computer, or any other type of computing device configured to perform the various operations described herein for distributing web-based software application extensions within documents. The network 104 may be an internet, the Internet, an intranet, or an extranet. Access to the network 104 may be provided via one or more wired or wireless access networks (not shown), as will be understood by those skilled in the art.

The user device A 102A is configured to communicate with a web add-in and marketplace server computer 106 to obtain web add-ins for one or more applications that execute on the user device A 102A, as will be described in greater detail herein. The user device A 102A is also configured to distribute one or more web add-ins to one or more other user devices, which, in the illustrated embodiment, include a user device B 102B and a user device N 102N. The user device A 102A may additionally or alternatively obtain web add-ins for one or more applications from the user device B 102B and/or the user device N 102N. The user device B 102B and the user device N 102N may be a personal computer (“PC”), desktop workstation, laptop computer, tablet computer, notebook computer, personal digital assistant (“PDA”), electronic-book reader, game console, set-top box, consumer electronics device, server computer, or any other type of computing device configured to perform the various operations described herein.

The user device A 102A is configured to execute an operating system 108 and one or more application programs such as, in the illustrated embodiment, a marketplace application 110, a web browser application 112, a web add-in development application 114, a distribution application 116, a web add-in enabled application 118, a web add-in viewer application 120, and/or one or more other applications (not shown). In some embodiments, two or more of the above applications 110, 112, 114, 116, 118, 120 are combined in a single application program. In some embodiments, the web add-in enabled application 118 includes one or more features provided by the marketplace application 110, the web browser application 112, the web add-in development application 114, the distribution application 116, and/or the web add-in viewer application 120. The operating system 108 is a computer program for controlling the operation of the user device A 102A. The application programs are executable programs configured to execute on top of the operating system 108 to provide various functionality described herein.

Although the applications 110, 114, 116, 118, 120 are illustrated as being hosted on the user device A 102A, one or more of these applications may be implemented as one or more websites or one or more web pages within one or more websites that are operating on the World Wide Web (“the Web”). In some embodiments, one or more of these applications is implemented on the web add-in and marketplace server computer 106 and/or one or more other servers, which are accessible by the user device A 102A via the web browser application 112. Moreover, although the user device A 102A is illustrated as including the applications 110, 112, 114, 116, 118, 120, in some implementations, the user device A 102A includes one or more of these applications, but not all of these applications as in the illustrated embodiment. Accordingly, the illustrated embodiment should not be interpreted as being limited to a device that necessarily includes all of the illustrated applications 110, 112, 114, 116, 118, 120.

The marketplace application 110 is an application program through which a user can access a virtual marketplace to obtain marketplace content, such as applications and web add-ins, which are hosted by the web add-in and marketplace server computer 106. The marketplace application 110, in some embodiments, is a marketplace client application installed on the user device A 102A and provides a graphical user interface (“GUI”) through which a user can browse marketplace content, search for marketplace content, download marketplace content, manage marketplace content, create and manage user accounts, read reviews on marketplace content, and otherwise interact with the web add-in and marketplace server computer 106. Although the marketplace application 110 is illustrated as residing on the user device A 102A with the applications 112, 114, 116, 118, 120, it should be understood that, in some implementations, the user device A 102A includes only the marketplace application 110 or the marketplace application 110 and one or more of the applications 112, 114, 116, 118, 120, but not all of these applications.

The web browser application 112 is an application program through which a user can access information resources on the Web via the network 104. In some embodiments, the web browser application 112 allows a user to access a marketplace website hosted by or for the web add-in and marketplace server computer 106. The marketplace website may provide a web-based GUI through which a user can browse marketplace content, search for marketplace content, download marketplace content, manage marketplace content, create and manage user accounts, read reviews on marketplace content, and otherwise interact with the web add-in and marketplace server computer 106. Although the web browser application 112 is illustrated as residing on the user device A 102A with the applications 110, 114, 116, 118, 120, it should be understood that, in some implementations, the user device A 102A includes only the web browser application 112 or the web browser application 112 and one or more of the applications 110, 114, 116, 118, 120, but not all of these applications.

The web add-in development application 114 is an application program through which a user can develop web add-ins. In some embodiments, the web add-in development application 114 is or includes a development environment in which web add-ins can be built using web technologies such as, but not limited to, HTML, Javascript, and REST. In some embodiments, the web add-in development application 114 includes functionality to facilitate submitting web add-ins to the web add-in and marketplace server computer 106 for inclusion in a virtual marketplace provided by the web add-in and marketplace server computer 106. In other embodiments, the marketplace application 110 provides this functionality. Although the web add-in development application 114 is illustrated as residing on the user device A 102A with the applications 110, 112, 116, 118, 120, it should be understood that, in some implementations, the user device A 102A includes only the web add-in development application 114 or the web add-in development application 114 and one or more of the applications 110, 112, 116, 118, 120, but not all of these applications.

The distribution application 116 is an application program through which a user can distribute documents containing web add-ins to the user device B 102B, the user device N 102N, and/or other users devices (not shown). In some embodiments, the distribution application 116 is an email application, such as MICROSOFT OUTLOOK, available from Microsoft Corporation of Redmond, Wash., through which a user can create an email, attach a document containing a web add-in to the email, and send the email to one or more email addresses that are associated with one or more users. In some embodiments, the distribution application 116 is a file sharing application through which a user can share a document containing a web add-in. It is contemplated that the file sharing application may or may not require a password or other authentication credentials to download the document containing the web add-in. In some embodiments, the distribution application 116 is a media application. In some embodiments, the distribution application 116 is included in another application and is provided, at least in part, for distributing the web add-in within the other application, which may or may not be configured to utilize the web add-in. In some embodiments, the distribution application 116 is a web application accessible through the web browser application 112. Although the distribution application 116 is illustrated as residing on the user device A 102A with the applications 110, 112, 114, 118, 120, it should be understood that, in some implementations, the user device A 102A includes only the distribution application 116 or the distribution application 116 and one or more of the applications 110, 114, 118, 120, but not all of these applications.

The web add-in enabled application 118 is an application program that is configured to facilitate the incorporation of one or more web add-ins into a document. In some embodiments, the web add-in enabled application 118 is an application such as, but not limited to, a word processing application, spreadsheet application, presentation application, drawing application, photography application, design application, video game application, music application, video application, or a collaboration application. In some embodiments, the web add-in enabled application 118 is MICROSOFT WORD, available from Microsoft Corporation of Redmond, Wash., MICROSOFT EXCEL, available from Microsoft Corporation of Redmond, Wash., MICROSOFT POWERPOINT, available from Microsoft Corporation of Redmond, Wash., MICROSOFT VISIO, available from Microsoft Corporation of Redmond, Wash., or MICROSOFT SHAREPOINT, available from Microsoft Corporation of Redmond, Wash. Alternatively, the web add-in enabled application 118 may be any other application that supports web add-ins. Although the web add-in enabled application 118 is illustrated as residing on the user device A 102A with the applications 110, 112, 114, 116, 120, it should be understood that, in some implementations, the user device A 102A includes only the web add-in enabled application 118 or the web add-in enabled application 118 and one or more of the applications 110, 112 114, 116, 120, but not all of these applications.

In some embodiments, the web browser application 112 facilitates access to web applications to configured to provide the same or similar functionality as described above for the web add-in enabled application 118.

The web add-in viewer application 120 is an application program that facilitates a user to view web add-ins in documents without the ability to modify the web add-ins. In some embodiments, the web add-in viewer application 120 is an older version of the web add-in enabled application 118 prior to the web add-in functionality having been enabled. In some embodiments, the web add-in viewer application 120 is an application such as, but not limited to, a word processing application, spreadsheet application, presentation application, drawing application, photography application, design application, video game application, music application, video application, a file viewer application, or a collaboration application. As will be described in greater detail herein, in some embodiments, the web add-in viewer application 120 is upgradeable to a newer version that is configured to facilitate the incorporation of one or more web add-ins into a document in a capacity similar to or as the web add-in enabled application 118. Although the web add-in viewer application 120 is illustrated as residing on the user device A 102A with the applications 110, 112, 114, 116, 118, it should be understood that, in some implementations, the user device A 102A includes only the web add-in viewer application 120 or the web add-in viewer application 120 and one or more of the applications 110, 112 114, 116, 118, but not all of these applications.

Although the web add-in enabled application 118 and the web add-in viewer application 120 are shown as residing in the user device A 102A, it should be understood that, in some implementations only the web add-in enabled application 118 or the web add-in viewer application 120 resides in the user device A 102A at a given time.

The user device A 102A is illustrated as being in communication with a document data store 122, a template data store 124, a web add-in data store 126, and an entitlement data store 128. The document data store 122, the template data store 124, the web add-in data store 126, and/or the entitlement data store 128 may be stored in a memory (not shown) of the user device A 102A or may be accessible from an external source that may be local or remote to the user device A 102A. In some embodiments, two or more of the data stores 122, 124, 126, 128 are combined.

The document data store 122 is configured to store documents such as, but not limited to, word processing documents, spreadsheet documents, presentation documents, drawings documents, collaboration documents, and/or other documents created by or for the web add-in enabled application 118 and/or the web add-in viewer application 120. The documents stored in the document data store 122 may have one or more web add-ins embedded within or attached thereto. The documents stored in the document data store 122 may be opened by the web add-in enabled application 118 and/or the web add-in viewer application 120. With the latter, a document may or may not include the same functionality that would be provided if the document was opened with the web add-in enabled application 118. In some embodiments, as will be described in greater detail herein, the web add-in viewer application 120 is upgradeable to the web add-in enabled application 118 or similar application so that one or more web add-ins can be edited or otherwise interacted with. The documents stored in the data store 122 may include new or blank documents; documents created on the user device A 102A; documents downloaded to the user device A 102A from a website, an email attachment, a file sharing application, and/or another computer or device such as the web add-in and marketplace server computer 106, the user device B 102B, or the user device N 102N; and/or documents transferred to the user device A 102A from an external memory device such as a flash memory drive, CD, DVD, or other physical media.

The template data store 124 is configured to store document templates for facilitating the creation of documents such as, but not limited to, word processing documents, spreadsheet documents, presentation documents, drawings documents, and collaboration documents. A template, as used herein, may be a style guide for a document. For instance, a word processing document template can include, but is not limited to including, formatting, styles, boilerplate text, headers, footers, macros, dictionaries, toolbars, and/or auto text entries. The document templates stored in the document template data store 124 may have one or more web add-ins embedded within or attached thereto. In these embodiments, the document template containing one or more web add-ins may effectively become an application that is functional without the need for the web add-in enabled application 118.

The document templates stored in the document template data store 124 may be opened by the web add-in enabled application 118 and/or the web add-in viewer application 120. With the latter, a document template may or may not include the same functionality that would be provided if the document was opened with the web add-in enabled application. In some embodiments, as will be described in greater detail herein, the web add-in viewer application 120 is upgradeable to the web add-in enabled application 118 or similar application so that one or more web add-ins and/or other features of a document template can be edited or otherwise interacted with. The document templates stored in the document template data store 124 may include new or blank document templates; document templates created on the user device A 102A; document templates downloaded to the user device A 102A from a website, an email attachment, a file sharing application, and/or another computer or device such as the web add-in and marketplace server computer 106, the user device B 102B, or the user device N 102N; and/or document templates transferred to the user device A 102A from an external memory device such as a flash memory drive, CD, DVD, or other physical media.

The web add-in data store 126 is configured to store web add-ins. More particularly, the web add-in data store 126 is configured to store web add-in manifests. The web add-in manifests each include a reference to and a description of one or more web servers, such as one or more web servers hosted by or for the web add-in and marketplace server computer 106, as described in greater detail below. The web add-in manifests stored in the web add-in data store 126 may include manifests created on the user device A 102A; manifests downloaded to the user device A 102A from a website, an email attachment, a document, a file sharing application, and/or another computer or device such as the web add-in and marketplace server computer 106, the user device B 102B, or the user device N 102N; and/or manifests transferred to the user device A 102A from an external memory device such as a flash memory drive, CD, DVD, or other physical media.

The entitlement data store 128 is configured to store entitlements for web add-ins, such as the web add-ins stored in the web add-in data store 126. Entitlements may include free entitlement, trial entitlements, and purchase entitlements. Free entitlements may be configured to provide full or reduced functionality. Trial entitlements allow a user to access a web add-in with one or more restriction for using the web add-in. These restrictions include, but are not limited to, time restrictions, use restrictions, functionality restrictions, or some combination thereof. In some embodiments, the user is provided an option to purchase the web add-in after expiration of the trial entitlement. Purchase entitlements may include multiple tiers, such as basic and premium. A premium purchase entitlement may provide additional functionality above and beyond the functionality provided with a basic purchase entitlement. Purchase entitlement may be subscription-based. Moreover, entitlements may be configured to auto-renew.

Time restrictions can be used to restrict the amount of time a web add-in can be used before a trial entitlement expires. In some embodiments, a time restriction is cumulative such that time using the web add-in is added until a time limit is reached, at which point the trial entitlement may expire. In some embodiments, a time restriction is reset after the time limit is reached. In these embodiments, any changes to the web add-in and/or to a document the web add-in to which the web add-in is being applied may be reset or may be saved if the user purchases the web add-in. In some embodiments, a time restriction is combined with a functionality restriction and/or a use restriction.

Use restrictions can be used to restrict the number of times a web add-in can be used before a trial entitlement expires. Use restrictions can be used to restrict usage of a web add-in to a certain number of users. For instance, a trial entitlement for a web add-in may be acquired for a group of users, but a use restriction can limit the maximum number of users to, say, three users at a given. In some embodiments, each use has a time limit or other time restriction associated therewith. In some embodiments, a use restriction is combined with a time restriction and/or a functionality restriction.

Functionality restrictions can be used to restrict the functionality of a web add-in. For instance, a functionality restriction may restrict the functionality of a web add-in to being viewable and printable but not editable. Other functionality restrictions are contemplated. In some embodiments, a functionality restriction is combined with a time restriction and/or a use restriction.

In some embodiments, a user is provided a coupon code, voucher, or some other mechanism by which the user can choose one or more free web add-ins from the virtual marketplace. The user may acquire such mechanism by purchasing a web add-in enabled application, such as the web add-in enabled application 118; with a trial version of the web add-in enabled application 118; or by way of a promotion.

The web add-in and marketplace server computer 106 is configured to execute a server operating system 130 and one or more application programs such as, in the illustrated embodiment, a marketplace server application 132, a web add-in server application 134, a transaction management application 136, an entitlement management application 138, and/or one or more other applications (not shown). The server operating system 130 is a computer program for controlling the operation of the web add-in and marketplace server computer 106. The application programs are executable programs configured to execute on top of the server operating system 130 to provide various functionality described herein.

Although the applications 132, 134, 136, 138 are illustrated as being hosted on the web add-in and marketplace server computer 106, in some implementations, these applications each reside on different servers (not shown) or are distributed over a plurality of servers. In some implementations, some other combination of the applications 132, 134, 136, 138 reside on the web add-in and marketplace server computer 106 and/or one or more different servers (not shown). Accordingly, the illustrated embodiment should not be interpreted as being limited to a server that necessarily includes all of the illustrated applications 132, 134, 136, 138.

The marketplace server application 132 is a server application program configured to provide infrastructure for a virtual marketplace through which web add-ins, and more particularly, web add-in manifests can be downloaded and purchased. The marketplace server application 132, in some embodiments, provides account creation and management tools to facilitate the creation and management of user and developer accounts. The marketplace server application 132, in some embodiments, is configured to communicate with a user account data store 140 for storing user accounts and associated user information such as username, password and/or other authentication credential(s), name, email address, mailing address, telephone number, user preferences, payment account information, favorites, and the like. The marketplace server application 132 is also configured to communicate with a developer account data store 142 for storing developer accounts and associated developer information, which may include information similar to the user information described above and may additionally or alternatively include developer specific information such as doing business as name, active web add-ins deployed on the marketplace, pending web add-ins, income deposit account information, and the like. Although the marketplace server application 132 is illustrated as residing on the web add-in and marketplace server computer 106 with the applications 134, 136, 138, it should be understood that, in some implementations, the web add-in and marketplace server computer 106 includes only the marketplace server application 132 or the marketplace server application 132 and one or more of the applications 134, 136, 138, but not all of these applications.

The marketplace server application 132, in some embodiments, facilitates, at least in part, a web add-in approval process through which a web add-in developer can submit a web add-in for inclusion in the virtual marketplace and receive an indication of whether or not the web add-in is accepted. The marketplace server application 132, in some embodiments, facilitates the submission of web add-in updates and descriptions for web add-in, and the management of web add-ins. In some embodiments, some or all of the aforementioned functionality is included in a separate marketplace developer portal application (not shown), which may operate on the web add-in and marketplace server computer 106 and/or one or more other server computers (also not shown).

In some embodiments, the marketplace server application 132 is a server application program that is configured to deliver web site content associated with a virtual marketplace to the user device A 102A. In particular, the marketplace server application 132 may host a web site or a portion thereof, may receive requests for web pages of the web site from the user device A 102A, and may deliver the web pages to the user device A 102A in response thereto. In some embodiments, the marketplace server application 132 provides a web-based version of the marketplace application 110 so that the marketplace is accessible from any computer or device that has an Internet connection instead of the marketplace application 110 having to be installed thereon.

The web add-in server application 134 is configured to enable features of one or more web add-ins, by providing one or more of the following: (1) one or more HTML files; (2) one or more Javascript files; and (3) one or more web services to access server-side functionality and content that add value to a document or application. Although the web add-in server application 134 is illustrated as residing on the web add-in and marketplace server computer 106 with the applications 132, 136, 138, it should be understood that, in some implementations, the web add-in and marketplace server computer 106 includes only the web add-in server application 134 or the web add-in server application 134 and one or more of the applications 132, 136, 138, but not all of these applications.

The transaction application 136 is a server application program that is configured to manage transactions between the web add-in and marketplace server computer 106 and other devices, such as the user device A 102A. In some embodiments, the transaction application 136 is configured to process payments for marketplace content, issue refunds where appropriate, and/or provide pay-outs to developers for income earned through the sale of the developers' applications and/or web add-ins in the virtual marketplace. In some embodiments, the transaction application 136 is configured to accept a proprietary currency that is useable within the virtual marketplace and may or may not be useable elsewhere. In some embodiments, the transaction application 136 communicates with one or more credit card company computers, bank computers, or other financial institutions to process payments and perform other operations described above. Although the transaction application 136 is illustrated as residing on the web add-in and marketplace server computer 106 with the applications 132, 134, 138, it should be understood that, in some implementations, the web add-in and marketplace server computer 106 includes only the transaction application 136 or the transaction application 136 and one or more of the applications 132, 134, 138, but not all of these applications.

The entitlement management application 138 is a server application program that is configured to manage entitlements for users of the virtual marketplace. In the illustrated embodiment, the web add-in and marketplace server computer 106 is configured to receive entitlement requests from the user device A 102A, the user device B 102B, and the user device N 102N, and to provide entitlement responses in response thereto. In particular, upon receipt of an entitlement request, the entitlement management application 138 can update an entitlement record for a user associated with the entitlement request to indicate the entitlement associated with the user for a particular web add-in. The entitlement management application 138, in some embodiments, handles restrictions and instructs the user device A 102A or other device to which an entitlement has been sent to prompt a user to purchase an entitlement upon expiration of a trial entitlement. The entitlement management application 138 is configured to perform other entitlement management operations described herein. Although the entitlement management application 138 is illustrated as residing on the web add-in and marketplace server computer 106 with the applications 132, 134, 136, it should be understood that, in some implementations, the web add-in and marketplace server computer 106 includes only the entitlement management application 138 or the entitlement management application 138 and one or more of the applications 132, 134, 136, but not all of these applications.

The web add-in and marketplace server computer 106 is illustrated as being in communication with the user account data store 140, the developer account data store 142, an entitlement data store 144, and a web add-in data store 146. The user account data store 140, the developer account data store 142, the entitlement data store 144, and the web add-in data store 146 may be stored in a memory (not shown) of the web add-in and marketplace server computer 106 or may be accessible from an external source that may be local or remote to the web add-in and marketplace server computer 106. In some embodiments, two or more of the data stores 140, 142, 144, 146 are combined.

The entitlement data store 144 is configured to store entitlements for web add-ins, such as the web add-ins stored in the web add-in data store 146. Entitlements may include free entitlements, trial entitlements, and purchase entitlements. Free entitlements may be configured to provide full or reduced functionality. Trial entitlements allow a user to access a web add-in with one or more restrictions for using the web add-in. These restrictions include, but are not limited to, time restrictions, use restrictions, functionality restrictions, or some combination thereof. In some embodiments, the user is provided an option to purchase the web add-in after expiration of the trial entitlement. Purchase entitlements may include multiple tiers, such as basic and premium. A premium purchase entitlement may provide additional functionality above and beyond the functionality provided with a basic purchase entitlement. In some embodiments, the entitlement data store 144 is configured to store entitlement terms.

Time restrictions can be used to restrict the amount of time a web add-in can be used before a trial entitlement expires. In some embodiments, a time restriction is cumulative such that time using the web add-in is added until a time limit is reached, at which point the trial entitlement may expire. In some embodiments, a time restriction is reset after the time limit is reached. In these embodiments, any changes to the web add-in and/or to a document the web add-in to which the web add-in is being applied may be reset or may be saved if the user purchases the web add-in. In some embodiments, a time restriction is combined with a functionality restriction and/or a use restriction.

Use restrictions can be used to restrict the number of times a web add-in can be used before a trial entitlement expires. Use restrictions can be used to restrict usage of a web add-in to a certain number of users. For instance, a trial entitlement for a web add-in may be acquired for a group of users, but a use restriction can limit the maximum number of users to, say, three users at a given. In some embodiments, each use has a time limit or other time restriction associated therewith. In some embodiments, a use restriction is combined with a time restriction and/or a functionality restriction.

Functionality restrictions can be used to restrict the functionality of a web add-in. For instance, a functionality restriction may restrict the functionality of a web add-in to being viewable and printable but not editable. Other functionality restrictions are contemplated. In some embodiments, a functionality restriction is combined with a time restriction and/or a use restriction.

The web add-in data store 146 is configured to store web add-ins. More particularly, the web add-in data store 146 is configured to store web add-in manifests. The web add-in manifests each include a reference to and a description of one or more web servers, such as the web add-in server application 134 and/or other web servers (not shown). The web add-ins stored in the web add-in data store 146 may include web add-ins created on the user device A 102A and uploaded to the web add-in and marketplace server computer 106 for inclusion in the virtual marketplace; web add-ins uploaded from other sources such as a developer; web add-ins downloaded from a website, an email attachment, a document, a file sharing application, and/or another computer or device; and/or web add-ins transferred to the web add-in and marketplace server computer 106 from an external memory device such as a flash memory drive, CD, DVD, or other physical media.

Although the marketplace server application 132, the web add-in server application 134, the transaction management application 136, and the entitlement management application 138 are illustrated as operating on the web add-in and marketplace server computer 106, it is contemplated that these applications, separately or together in some combination, may operate on one or more other server computers (not shown). In some embodiments, two or more of the marketplace server application 132, the web add-in server application 134, the transaction management application 136, and the entitlement management application 138 are combined.

In the illustrated embodiment, the user device A 102 is configured to download a web add-in 148 from the web add-in and marketplace server computer 106 and distribute the web add-in 148 to the user device B 102B and to the user device N 102N. Each user device is configured to generate and send an entitlement request 150A to the web add-in and marketplace server computer 106 and to receive an entitlement response 150B from the web add-in and marketplace server computer 106 in response thereto, as will be described in greater detail herein below.

It should be understood that some implementations of the operating environment 100 include multiple networks 104, multiple web add-in and marketplace server computers 106, multiple document data stores 122, multiple template data stores 124, multiple web add-in data stores 126, multiple entitlement data stores 128, multiple user account data stores 140, multiple developer account data stores 142, multiple entitlement data stores 144, and/or multiple web add-in data stores 146. It should also be understood that multiple operating systems 108, multiple marketplace applications 110, multiple web browser applications 112, multiple web add-in development applications 114, multiple distribution applications 116, multiple web add-in enabled applications 118, and/or multiple web add-in viewer applications 120 may be used by the user device A 102A or one or more other user devices, such as the user device B 102B, the user device N 102N, or other devices (not shown). It should also be understood that multiple server operation systems 130, multiple marketplace server applications 132, multiple web add-in server applications 134, multiple transaction applications 136, and/or multiple entitlement management applications may be used by the web add-in and marketplace server computer 106 and/or one or more other server computers (not shown). Thus, the illustrated embodiments should be understood as being illustrative, and should not be construed as being limiting in any way unless otherwise noted.

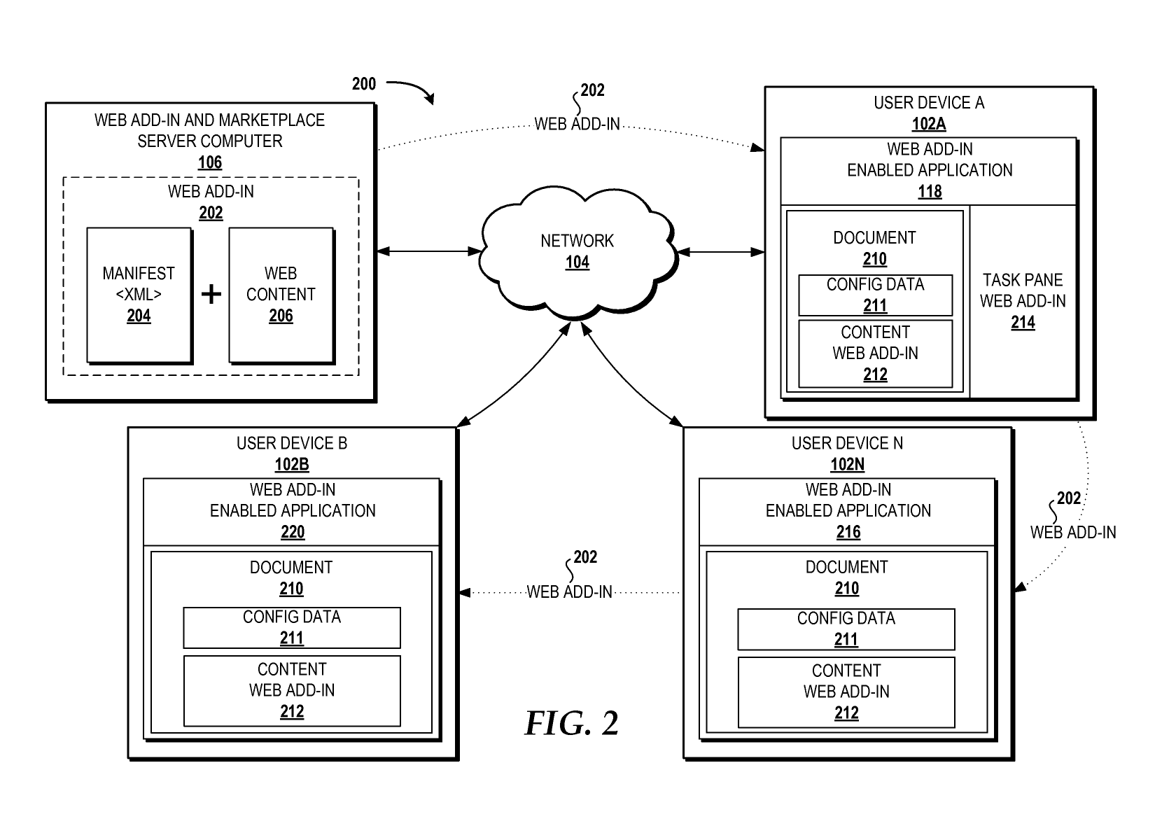

Turning now to FIG. 2, aspects of an operating environment 200 for distributing web add-ins will be described, according to an illustrative embodiment. The operating environment 200 shown in FIG. 2 includes the web add-in and marketplace server computer 106, the user device A 102, the user device B 102B, and the user device N 102N, each of which is in communication with the network 104. In the illustrated embodiment, the web add-in and marketplace server computer 106 sends a web add-in 202 to the user device A 102A, which, in turn, distributes the web add-in 202 to the user device N 102N, which then distributes the web add-in 202 to the user device B 102B.

As shown in the web add-in and marketplace server computer 106, the web add-in 202 includes a manifest 204 and web content 206. The web content 206 may include data from a webpage and/or a web service provided by a web server, such as the web add-in server application 134 (shown in FIG. 1) or one or more other web servers (not shown). The manifest 204, in some embodiments, is an extensible markup language (“XML”) manifest file that points to the web content 206. In some embodiments, the manifest 204 specifies a unique identity and the desired integration behavior of the web add-in 202 with an application, such as the web add-in enabled application 118. For instance, the manifest 204 can specify the uniform resource locator (“URL”) at which the web content 206 can be accessed, how the web add-in 202 is to be shown (e.g., in a task pane or as embedded content), the application(s) the web add-in 202 supports, and data access requirements, among other details of the web add-in 202.

In the illustrated embodiment, the user device A 102A includes the web add-in enabled application 118, which is configured to present a document 210. Based upon the details included in the manifest 204, and based upon configuration data 211 of the web add-in 202, the web add-in 202 can be used by the web add-in enabled application 118 to present the web content 206 within the document 210 as a content web add-in 212 and/or as a task pane web add-in 214. Other types of web add-ins, such as those described above, may alternatively or additionally be represented in the document 210.

The configuration data 211 provides details regarding a configuration of the web add-in 202. For example, if the content web add-in 212 shows you a breakdown of a company's sales in Europe over a 12 month period, the configuration data 211 could contain (a) which query a user wanted to execute, such as region=Europe, date_range=365 days, and (b) authentication information, such as a username and password to access the company's account. Alternatively, the configuration data 211 may contain a request for authentication information such as a username and password that can be presented to a user before or during presentation of the web add-in 202. In some embodiments, at least a portion of the web add-in 202 is viewable without the authentication information. In these embodiments, the authentication information may be required for the user to use and/or edit the web add-in 202. The configuration data 211, in some embodiments, includes metadata.

The configuration data 211 is provided in addition to the manifest and the web content 206 coming from the web add-in and marketplace server computer 106. These are merely examples of what the configuration data 211 could contain and other configuration data is contemplated. Another example is the ability to bind the configuration data 211 in the document (e.g., a range of cells) to a web service that will act upon them (e.g., run statistical analysis on the range of cells). The configuration data 211 may be associated with a content web add-in (e.g., the illustrated content web add-in 212), a task pane web add-in (e.g., the task pane web add-in 214), or another type of web add-in, such as described above.

The user device A 102A, in the illustrated embodiment, distributes the web add-in 202 within the document 210 to the user device N 102N. More particularly, the user device A 102A distributes the manifest 204 or a reference to the manifest 204, the configuration data 211, and a static snapshot (not shown) of how the web add-in 202 should appear in cases where the recipient cannot run the web add-in 202 (e.g., legacy applications), or in cases where the recipient chooses not to run the web add-in 202 (e.g., the recipient does not trust the web add-in 202). Examples include, but are not limited to, a screenshot of a webpage or other web content that would be shown, or a static snapshot of numerical and/or other data that would normally be kept updated by the web add-in 202.

In some embodiments, the static snapshot of the web add-in 202 is stored in the document, and thus does not require access to an external web server to show features of the web add-in 202. In some embodiments, publication of the information provided by or the results of executing the web add-in 202 are represented in static form as a static snapshot without providing the ability to modify a document with which the web add-in 202 is associated. In these embodiments, users can avoid showing their work that utilized, at least in part, the web add-in 202 to create.

The user device N 102N, in the illustrated embodiment, includes a web add-in enabled application 216 that, for purposes of explanation, is configured like the web add-in enabled application 118. The web add-in enabled application 216 is configured to present the document 210. In the illustrated embodiment, the web add-in 202 received from the user device A 102A is the content web add-in 212 and, as such, the content web add-in 212 is displayed in the document 210. Alternatively or additionally, the task pane web add-in 214 and/or some other web add-in (not shown) can be received from the user device A 102A. The user device N 102N, in the illustrated embodiment, distributes the web add-in 202 within the document 210 to the user device B 102B.

The user device B 102B, in the illustrated embodiment, includes a web add-in enabled application 220 that, for purposes of explanation, is configured like the web add-in enabled application 118. The web add-in enabled application 220 is configured to present the document 210. In the illustrated embodiment, the web add-in 202 received from the user device N 102N is the content web add-in 212 and, as such, the content web add-in 212 is displayed in the document 210. Alternatively or additionally, the task pane web add-in 214 or some other web add-in (not shown) can be received from the user device N 102N.

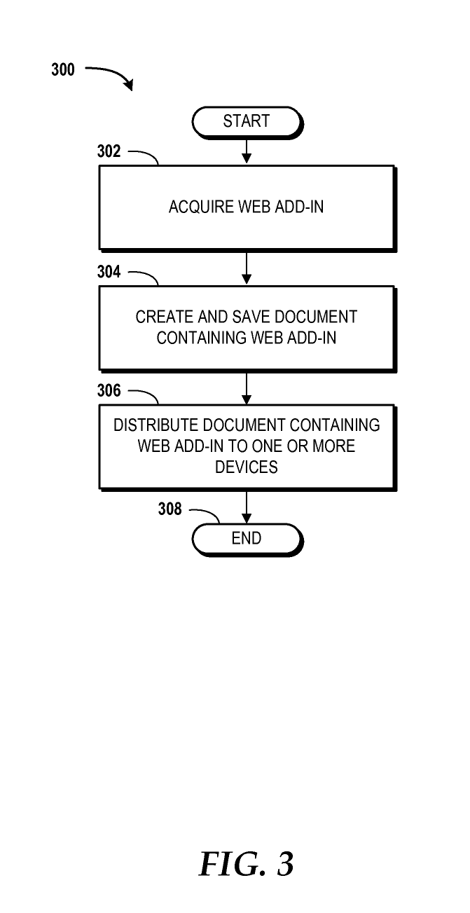

Turning now to FIG. 3, aspects of a method 300 for distributing web add-ins within documents will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their respective entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, processor-based, programmable consumer electronics, combinations thereof, and the like.

Thus, it should be appreciated that the logical operations described herein are implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

The method 300 will now be described with reference to FIGS. 1 and 2. The method 300 begins at operation 302, wherein the user device A 102A acquires a web add-in (e.g., the web add-in 148 or the web add-in 202) from the web add-in and marketplace server computer 106. Alternatively, in some embodiments, the user device A 102A receives the web add-in from another device, such as the user device B 102B, the user device N 102N, a website, or any other source. In some embodiments, the web add-in is created on the user device A 102A using the web add-in development application 114. In some embodiments, the user device A 102A acquires the web add-in in a template, which contains a document including the web add-in. The template can be used to create a document.

Although operation 302 references a web add-in being received, it should be understood that the use of a web add-in here is for ease of explanation. What is acquired in operation 302 may be, more particularly, a manifest (e.g., the manifest 204) or a reference to a manifest, configuration data (e.g., the configuration data 211), and a static snapshot (not shown) of how the web add-in should appear in cases where the recipient cannot run the web add-in (e.g., legacy applications), or in cases where the recipient chooses not to run the web add-in (e.g., the recipient does not trust the web add-in). In some embodiments, the reference to the manifest is a uniform resource locator (“URL”). In some embodiments, the manifest is saved in a different location (e.g., the web add-in data store 146) from the web add-in data server (e.g., the web add-in data server application 134) to which the manifest file points.

From operation 302, the method 300 proceeds to operation 304, wherein the user device A 102A creates and saves a document (e.g., the document 210) containing the web add-in using the web add-in enabled application 118. The creation of the document may include creating a document containing just the web add-in. In other words, the document itself may be blank except for the web add-in. Alternatively, the document may contain content in addition to the web add-in. The save step may include transforming the dynamic nature of the web add-in into a static snapshot. This has the advantage of ensuring wider compatibility with web add-in viewer applications (e.g., the web add-in viewer application 120), rather than just applications capable of running/editing web add-ins (e.g., the web add-in enabled application 118).

From operation 304, the method 300 proceeds to operation 306, wherein the user device A 102A distributes the document containing the web add-in to one or more other devices, such as the user device B 102B and/or the user device N 102N, using the distribution application 116. The method 300 then proceeds to operation 308, wherein the method 300 ends.

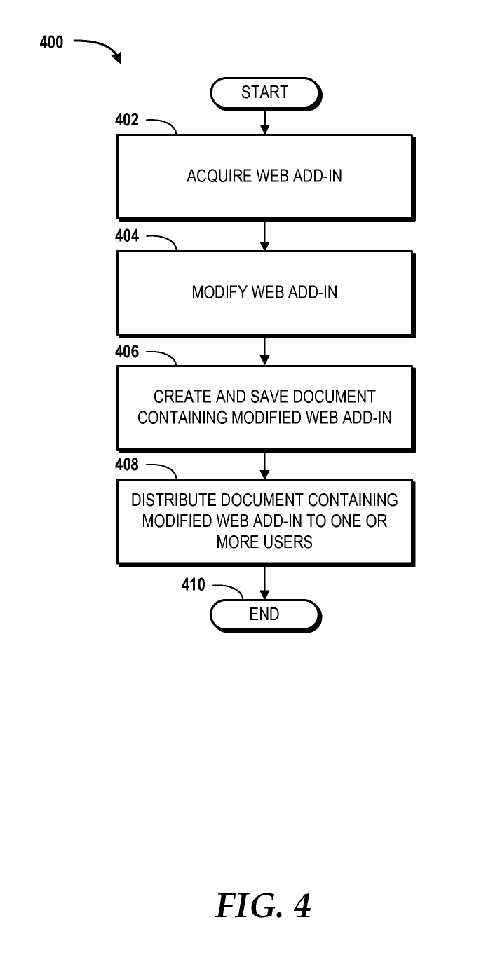

Turning now to FIG. 4, aspects of a method 400 for distributing modified web add-ins within documents will be described, according to an illustrative embodiment. The method 400 will now be described with reference to FIGS. 1 and 2. The method 400 begins and proceeds to operation 402, wherein the user device A 102A acquires a web add-in (e.g., the web add-in 148 or the web add-in 202) from the web add-in and marketplace server computer 106. Alternatively, in some embodiments, the user device A 102A receives the web add-in from another device, such as the user device B 102B, the user device N 102N, a website, or any other source. In some embodiments, the web add-in is created on the user device A 102A using the web add-in development application 114. In some embodiments, the user device A 102A receives the web add-in in a template, which contains a document including the web add-in. The template can be used to create a document.

Although operation 402 references a web add-in being acquired, it should be understood that the use of a web add-in here is for ease of explanation. What is acquired in operation 402 may be, more particularly, a manifest (e.g., the manifest 204) or a reference to a manifest, configuration data (e.g., the configuration data 211), and a static snapshot (not shown) of how the web add-in should appear in cases where the recipient cannot run the web add-in (e.g., legacy applications), or in cases where the recipient chooses not to run the web add-in (e.g., the recipient does not trust the web add-in).

From operation 402, the method 400 proceeds to operation 404, wherein the user device A 102A receives user input and modifies the web add-in in accordance with the user input using the web add-in enabled application 118 and/or the web add-in development application 114. Moreover, at operation 404, modification of the web add-in creates configuration data, which is embedded within a document alongside a web add-in manifest or a reference thereto. The method 400 then proceeds to operation 406, wherein the user device A 102A creates and saves a document (e.g., the document 210) containing the web add-in using the web add-in enabled application 118. The creation of the document may include creating a document containing just the modified web add-in. In other words, the document itself may be blank except for the web add-in. Alternatively, the document may contain content in addition to the web add-in. The save step may include transforming the dynamic nature of the web add-in into a static snapshot. This has the advantage of ensuring wider compatibility with web add-in viewer applications (e.g., the web add-in viewer application 120), rather than just applications capable of running/editing web add-ins (e.g., the web add-in enabled application 118). The method 400 then proceeds to operation 408, wherein the user device A 102A distributes the document containing the web add-in to one or more other devices, such as the user device B 102B and/or the user device N 102N, using the distribution application 116. The method 400 then proceeds to operation 410, wherein the method 400 ends.

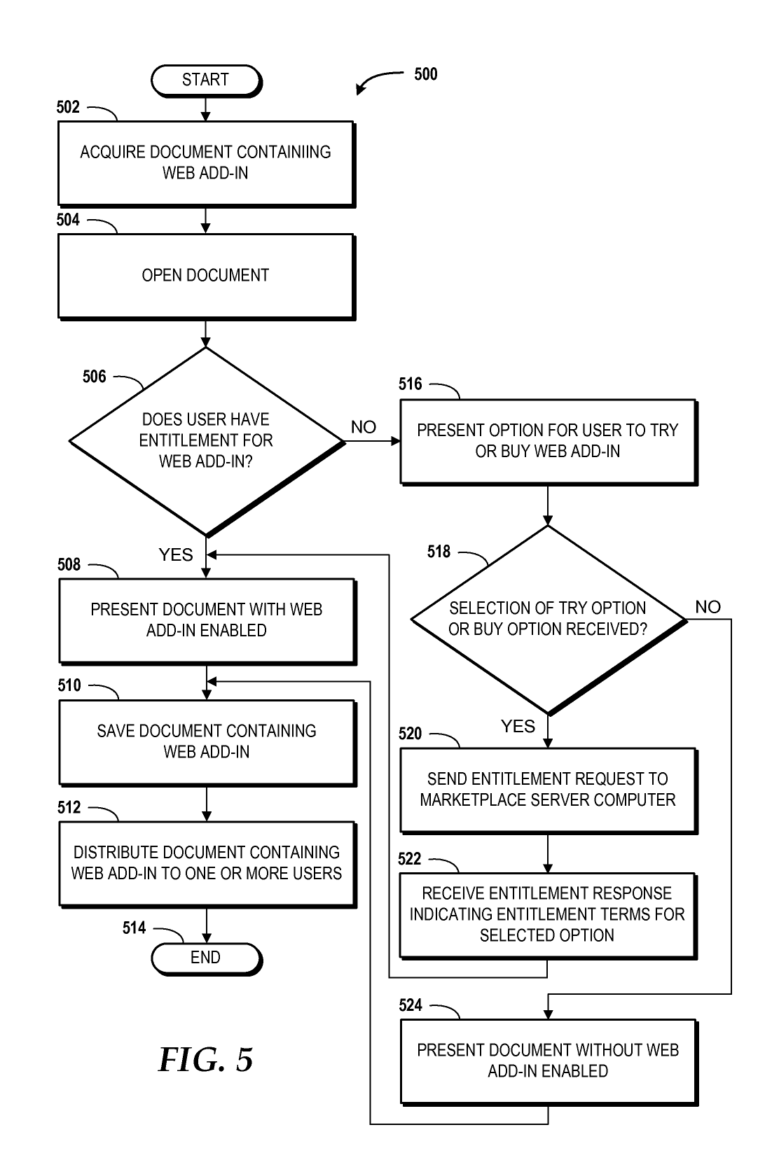

Turning now to FIG. 5, aspects of a method 500 for distributing web add-ins within documents will be described, according to an illustrative embodiment. The method 500 will now be described with reference to FIGS. 1 and 2. The method 500 begins and proceeds to operation 502, wherein the user device A 102A acquires a document (e.g., the document 210) containing a web add-in (e.g., the web add-in 148 or the web add-in 202). From operation 502, the method 500 proceeds to operation 504, wherein the user device A 102A opens the document using the web add-in enabled application 118. The method 500 then proceeds to operation 506, wherein the user device A 102A determines if a user operating the user device A 102A has an entitlement for the web add-in contained within the document.

In some embodiments, the web add-in enabled application 118 queries the entitlement data store 128 to determine if the user has an entitlement for the web add-in. In some embodiments, the web add-in enabled application 118 queries the web add-in and marketplace server computer 106 to determine if the user has an entitlement for the web add-in. In these embodiments, the entitlement management application 138 receives the query and queries the entitlement data store 144 to determine if the user has an entitlement for the web add-in.

In some embodiments, the user signs in to the web add-in enabled application 118 using an identity that is known to the web add-in and marketplace server computer 106. The entitlement management application 138 looks up entitlements for the user in the entitlement data store 144 to verify the user is entitled. In other embodiments, the user does not sign-in to the web add-in enabled application 118, but does see a prompt to sign-in directly to the web add-in and marketplace server computer 106. In yet other embodiments, separate users (called purchasers) may go through an entitlement transaction process to acquire multi-user entitlements, which are saved to a centralized server within the user's Intranet environment, for example, a collaboration environment provided by collaboration software such as MICROSOFT SHAREPOINT, available from Microsoft Corporation of Redmond, Wash. The user of device 102A may thus receive entitlements by signing-in to their Intranet and acquiring entitlements from SHAREPOINT instead of, or in addition to, the entitlements acquired from the marketplace via the web add-in and marketplace server computer 106. In some embodiments, entitlements for the web add-in can be purchased for a group of users and loaded into a SHAREPOINT server's catalog. Then, at run-time, the web add-in's manifest is sourced from the SHAREPOINT server, thereby allowing the users to use web add-ins without exposing themselves to arbitrary developer changes.

If, at operation 506, the user device A 102A determines that the user has an entitlement for the web add-in, the method 500 proceeds to operation 508, wherein the user device A 102A presents the document with the web add-in enabled using the web add-in enabled application 118. The method 500 then proceeds to operation 510, wherein the user device A 102A saves the document containing the web add-in using the web add-in enabled application 118. Moreover, at operation 510, configuration data is also saved and is embedded within the document alongside a web add-in manifest or a reference thereto. The save step may include transforming the dynamic nature of the web add-in into a static snapshot. This has the advantage of ensuring wider compatibility with web add-in viewer applications (e.g., the web add-in viewer application 120), rather than just applications capable of running/editing web add-ins (e.g., the web add-in enabled application 118). The method 500 then proceeds to operation 512, wherein the user device A 102A distributes the document containing the web add-in to one or more other devices, such as the user device B 102B and/or the user device N 102N, using the distribution application 116. The method 500 then proceeds to operation 514 and the method 500 ends.

If, at operation 506, the user device A 102A determines that the user does not have an entitlement for the web add-in, the method 500 proceeds to operation 516, wherein the user device A 102A presents an option for the user to try or buy the web add-in. The options may be displayed within the web add-in in the document or by the web add-in enabled application 118. In some embodiments, the web add-in is free, but in order to be implemented a user may be required to accept terms and conditions of use. In these embodiments, a different option or prompt may be displayed within the web add-in in the document or by the web add-in enabled application 118 to ask the user to accept the terms and conditions before the user is provided the free entitlement for the web add-in.

From operation 516, the method 500 proceeds to operation 518, wherein the user device A 102A determines if a selection of the try option or the buy option was received. If, at operation 518, the user device A 102A determines that either the try option or the buy option was selected, the method 500 proceeds to operation 520, wherein the user device A 102A sends an entitlement request to the web add-in and marketplace server computer 106. The entitlement request includes a request for a trial entitlement for the web add-in or a purchase entitlement depending upon whether the trial option or the buy option was selected. In response to receiving the entitlement request, the web add-in and marketplace server computer 106 and, particularly, the entitlement management application 118 updates a user account for the user of the user device A 102A to include an entitlement in accordance with the selected option. If the buy option was selected, the transaction application 136 can arrange for payment for the entitlement either by a payment account on record or by prompting the user to enter payment details from the user device A 102A. The terms of the entitlement are obtained from the entitlement data store 144. From operation 520, the method 500 proceeds to operation 522, wherein the user device A 102A receives an entitlement response from the web add-in and marketplace server computer 106. The entitlement response includes the terms of the entitlement obtained from the entitlement data store 144. The method 500 then proceeds to operation 508, wherein the user device A 102A presents the document with the web add-in enabled using the web add-in enabled application 118. At operation 510, the user device A 102A saves the document containing the web add-in using the web add-in enabled application 118. Moreover, at operation 510, configuration data is also saved and is embedded within the document alongside a web add-in manifest or a reference thereto. The save step may include transforming the dynamic nature of the web add-in into a static snapshot. This has the advantage of ensuring wider compatibility with web add-in viewer applications (e.g., the web add-in viewer application 120), rather than just applications capable of running/editing web add-ins (e.g., the web add-in enabled application 118).

From operation The method 500 then proceeds to operation 512, wherein the user device A 102A distributes the document containing the web add-in to one or more other devices, such as the user device B 102B and/or the user device N 102N, using the distribution application 116. The method 500 then proceeds to operation 514, wherein the method 500 ends.

If, at operation 518, the user device A 102A determines that neither the try option nor the buy option was selected, the method 500 proceeds to operation 524, wherein the user device A 102A presents the document without the web add-in being enabled using the web add-in enabled application 118. In such cases, the static snapshot may be used instead of a live working web add-in. The method 500 then proceeds to operation 508, wherein the user device A 102A presents the document with the web add-in enabled using the web add-in enabled application 118. At operation 510, the user device A 102A saves the document containing the web add-in using the web add-in enabled application 118. The method 500 then proceeds to operation 512, wherein the user device A 102A distributes the document containing the web add-in to one or more other devices, such as the user device B 102B and/or the user device N 102N, using the distribution application 116. From operation 512, the method 500 proceeds to operation 514, wherein the method 500 ends.

It should be understood that web add-in can iterate independently of a document in which the web add-in is contained. As such, the document can be better when a user opens it than when the author originally created it.

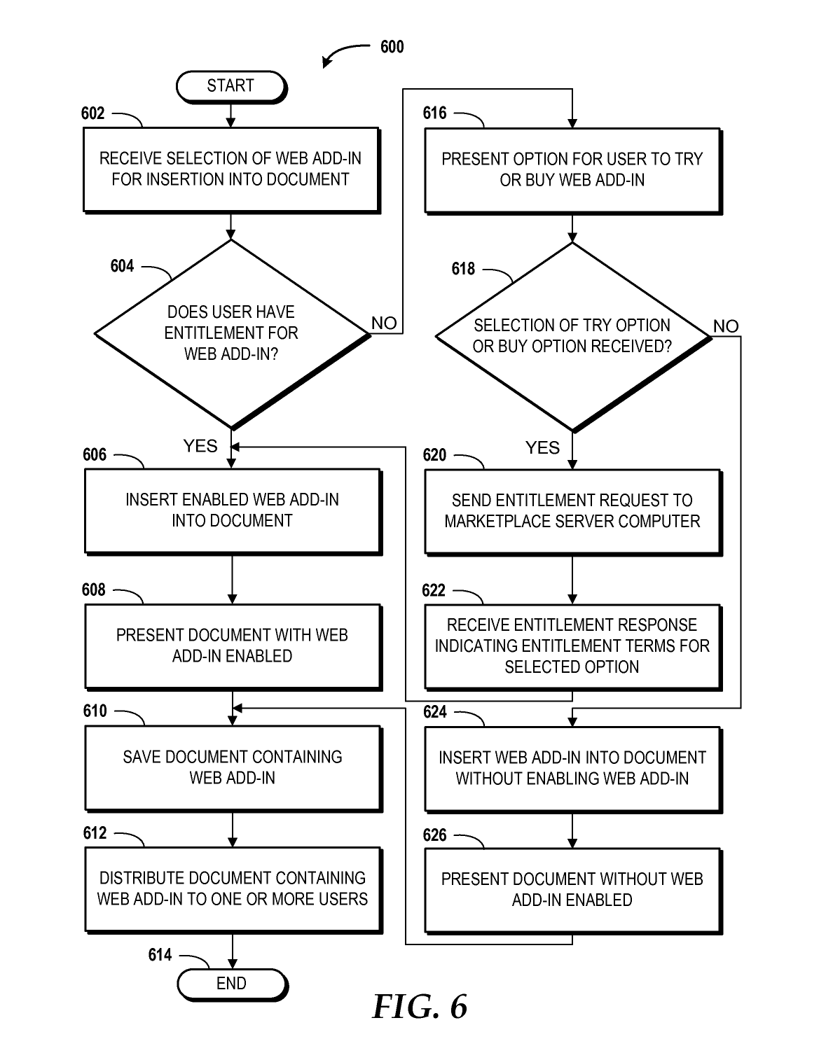

Turning now to FIG. 6, aspects of a method 600 for distributing web add-ins within documents will be described, according to an illustrative embodiment. The method 600 will now be described with reference to FIGS. 1 and 2. The method 600 begins and proceeds to operation 602, wherein the user device A 102A receives a selection of a web add-in (e.g., the web add-in 148 or the web add-in 202) for insertion into a document (e.g., the document 210) using the web add-in enabled application 118. In response to receiving the selection, at operation 604, the user device A 102A determines if a user operating the user device A 102A has an entitlement for the web add-in contained within the document.

In some embodiments, the web add-in enabled application 118 queries the entitlement data store 128 to determine if the user has an entitlement for the web add-in. In some embodiments, the web add-in enabled application 118 queries the web add-in and marketplace server computer 106 to determine if the user has an entitlement for the web add-in. In these embodiments, the entitlement management application 118 receives the query and queries the entitlement data store 144 to determine if the user has an entitlement for the web add-in.

In some embodiments, the user signs in to the web add-in enabled application 118 using an identity that is known to the web add-in and marketplace server computer 106. The entitlement management application 138 looks up entitlements for the user in the entitlement data store 144 to verify the user is entitled. In other embodiments, the user does not sign-in to the web add-in enabled application 118, but does see a prompt to sign-in directly to the web add-in and marketplace server computer 106. In yet other embodiments, separate users (called purchasers) may go through an entitlement transaction process to acquire multi-user entitlements, which are saved to a centralized server within the user's Intranet environment, for example, a collaboration environment provided by collaboration software such as MICROSOFT SHAREPOINT, available from Microsoft Corporation of Redmond, Wash. The user of device 102A may thus receive entitlements by signing-in to their Intranet and acquiring entitlements from SHAREPOINT instead of, or in addition to, the entitlements received from the marketplace via the web add-in and marketplace server computer 106.

If, at operation 604, the user device A 102A determines that the user has an entitlement for the web add-in, the method 600 proceeds to operation 606, wherein the web add-in is enabled and inserted into the document. From operation 606, the method 600 proceeds to operation 608, wherein the user device A 102A presents the document with the web add-in enabled using the web add-in enabled application 118. The method 600 then proceeds to operation 610, wherein the user device A 102A saves the document containing the web add-in using the web add-in enabled application 118. Moreover, at operation 610, configuration data is also saved and is embedded within the document alongside a web add-in manifest or a reference thereto. The save step may include transforming the dynamic nature of the web add-in into a static snapshot. This has the advantage of ensuring wider compatibility with web add-in viewer applications (e.g., the web add-in viewer application 120), rather than just applications capable of running/editing web add-ins (e.g., the web add-in enabled application 118). At operation 612, the user device A 102A distributes the document containing the web add-in to one or more other devices, such as the user device B 102B and/or the user device N 102N, using the distribution application 116. From operation 612, the method 600 proceeds to operation 614, wherein the method 600 ends.

If, at operation 604, the user device A 102A determines that the user does not have an entitlement for the web add-in, the method 600 proceeds to operation 616, wherein the user device A 102A presents an option for the user to try or buy the web add-in using the web add-in enabled application 118. In some embodiments, the web add-in is free, but in order to be implemented a user may be required to accept terms and conditions of use. In these embodiments, a different option or prompt may be displayed within the web add-in in the document or by the web add-in enabled application 118 to ask the user to accept the terms and conditions before the user is provided the free entitlement for the web add-in.

From operation 616, method 600 then proceeds to operation 618, wherein the user device A 102A determines if a selection of the try option or the buy option was received. If, at operation 618, the user device A 102A determines that either the try option or the buy option was selected, the method 600 proceeds to operation 620, wherein the user device A 102A sends an entitlement request to the web add-in and marketplace server computer 106. The entitlement request includes a request for a trial entitlement for the web add-in or a purchase entitlement depending upon whether the trial option or the buy option was selected. In some embodiments, not only is the current web add-in purchased, but one or more other web add-ins in the same document or template is purchased. In response to receiving the entitlement request, the web add-in and marketplace server computer 106 and, particularly, the entitlement management application 118 updates a user account for the user of the user device A 102A to include an entitlement in accordance with the selected option. The terms of the entitlement are obtained from the entitlement data store 144.

From operation 620, the method 600 proceeds to operation 622, wherein the user device A 102A receives an entitlement response from the web add-in and marketplace server computer 106. The entitlement response includes the terms of the entitlement obtained from the entitlement data store 144. The method 600 then proceeds to operation 606, wherein the user device A 102A inserts an enabled version of the web add-in into the document using the web add-in enabled application 118. From operation 606, the method 600 proceeds to operation 608, wherein the user device A 102A presents the document with the web add-in enabled using the web add-in enabled application 118. The method 600 then proceeds to operation 610, wherein the user device A 102A saves the document containing the web add-in using the web add-in enabled application 118. Moreover, at operation 610, configuration data is also saved and is embedded within the document alongside a web add-in manifest or a reference thereto. The save step may include transforming the dynamic nature of the web add-in into a static snapshot. This has the advantage of ensuring wider compatibility with web add-in viewer applications (e.g., the web add-in viewer application 120), rather than just applications capable of running/editing web add-ins (e.g., the web add-in enabled application 118).

At operation 612, the user device A 102A distributes the document containing the web add-in to one or more other devices, such as the user device B 102B and/or the user device N 102N, using the distribution application 116. The method 600 then proceeds to operation 614, wherein the method 600 ends.

If, at operation 618, the user device A 102A determines that neither the try option nor the buy option was selected, the method 600 proceeds to operation 624, wherein the user device A 102A inserts the web add-in into the document without enabling the web add-in using the web add-in enabled application 118. In some embodiments, the web add-in is inserted and can be viewed but not edited. In some embodiments, the web add-in is inserted and can be viewed and printed. In any case, the method 600 then proceeds to operation 626, wherein the user device A 102A presents the document without the web add-in being enabled using the web add-in enabled application 118. From operation 608, the method 600 proceeds to operation 610, wherein the user device A 102A saves the document containing the web add-in using the web add-in enabled application 118. Moreover, at operation 610, configuration data is also saved and is embedded within the document alongside a web add-in manifest or a reference thereto. The save step may include transforming the dynamic nature of the web add-in into a static snapshot. This has the advantage of ensuring wider compatibility with web add-in viewer applications (e.g., the web add-in viewer application 120), rather than just applications capable of running/editing web add-ins (e.g., the web add-in enabled application 118).

The method 600 then proceeds to operation 612, wherein the user device A 102A distributes the document containing the web add-in to one or more other devices, such as the user device B 102B and/or the user device N 102N, using the distribution application 116. Accordingly, even though the web add-in was not enabled for the user of the user device A 102A, the web add-in can still be distributed to other devices through which other users can access the web add-in and try or buy the web add-in if they do not already have an entitlement for it. The method 600 then proceeds to operation 614, wherein the method 600 ends.

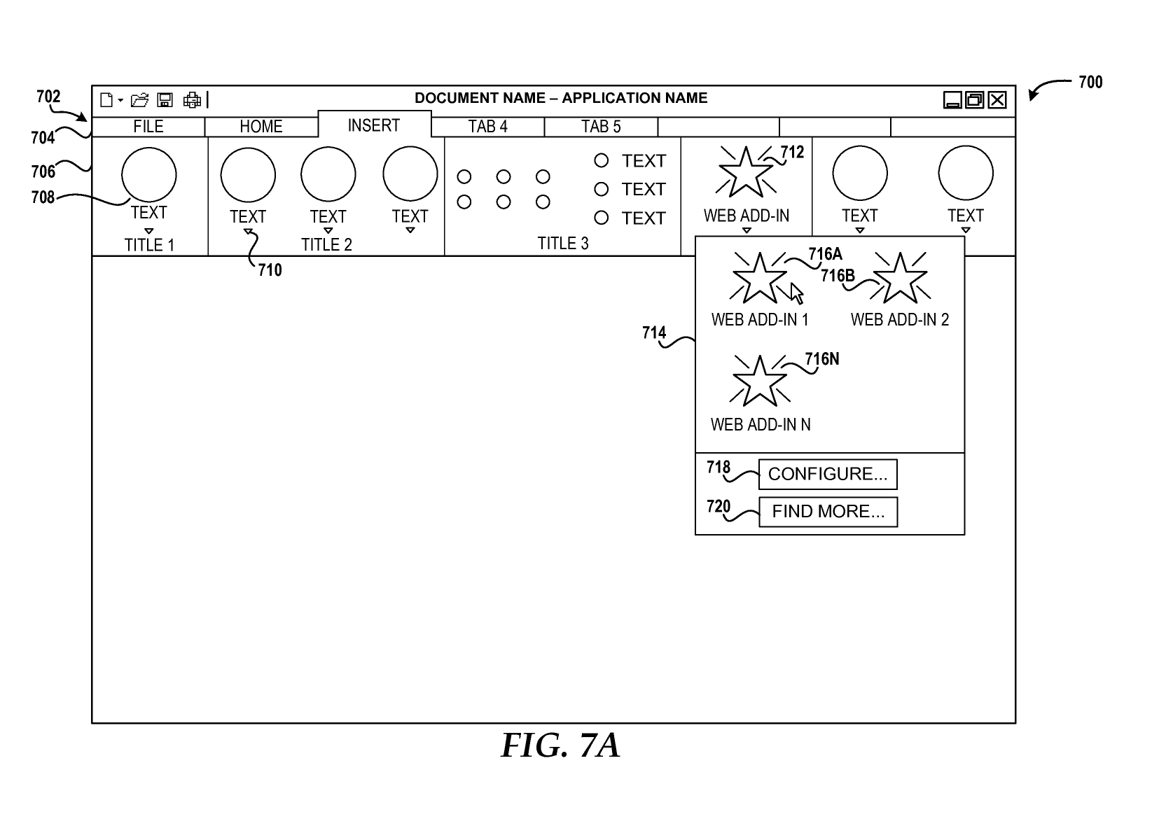

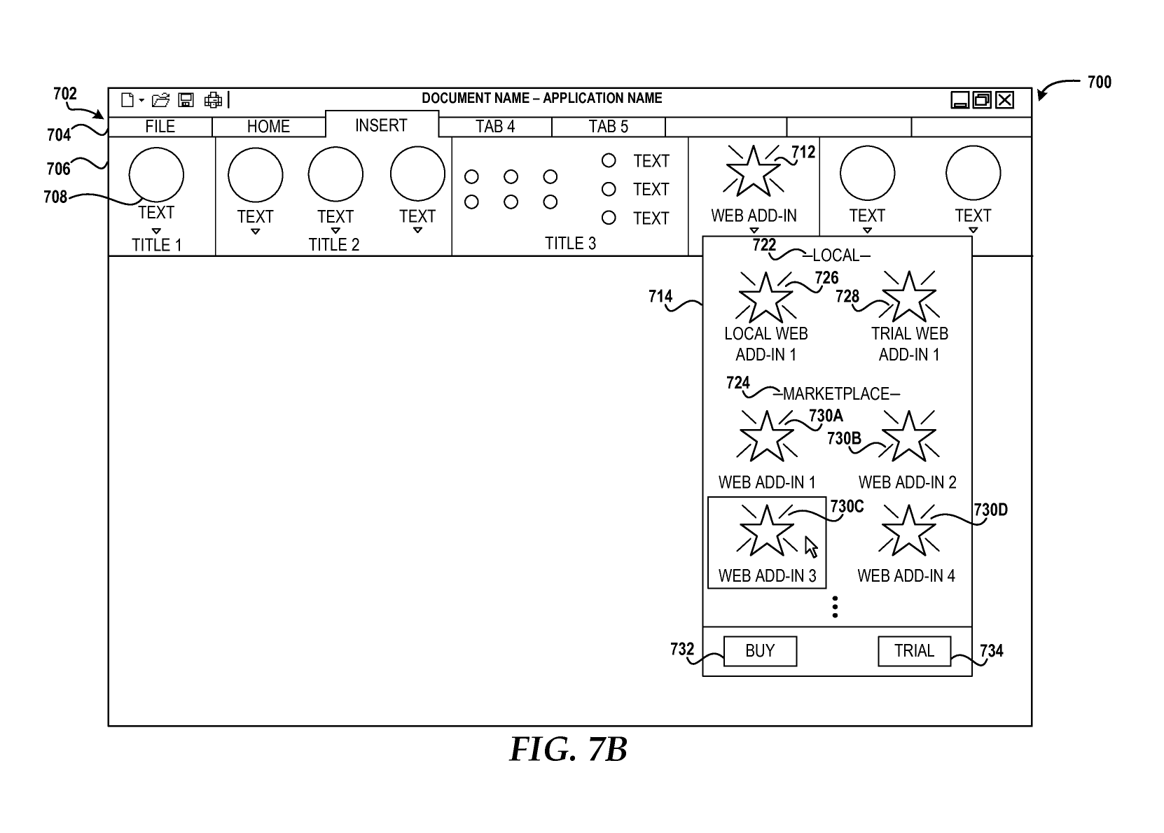

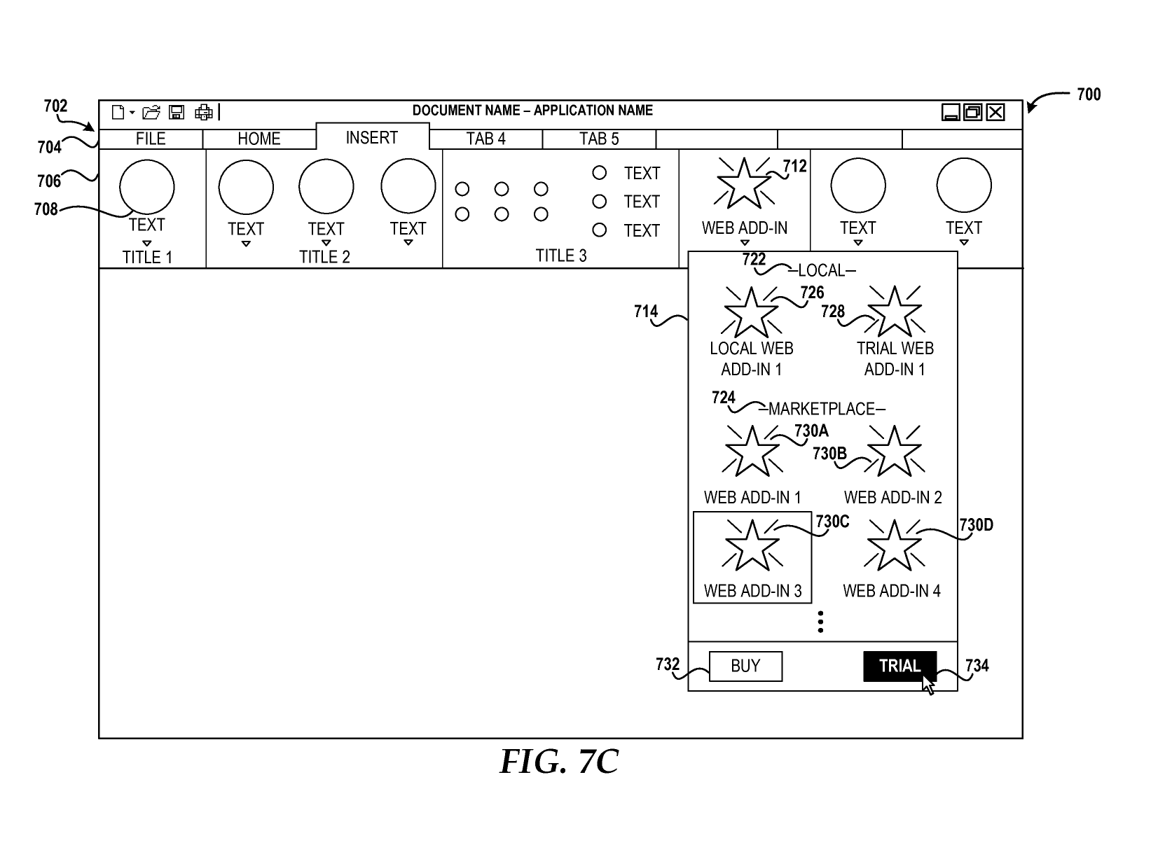

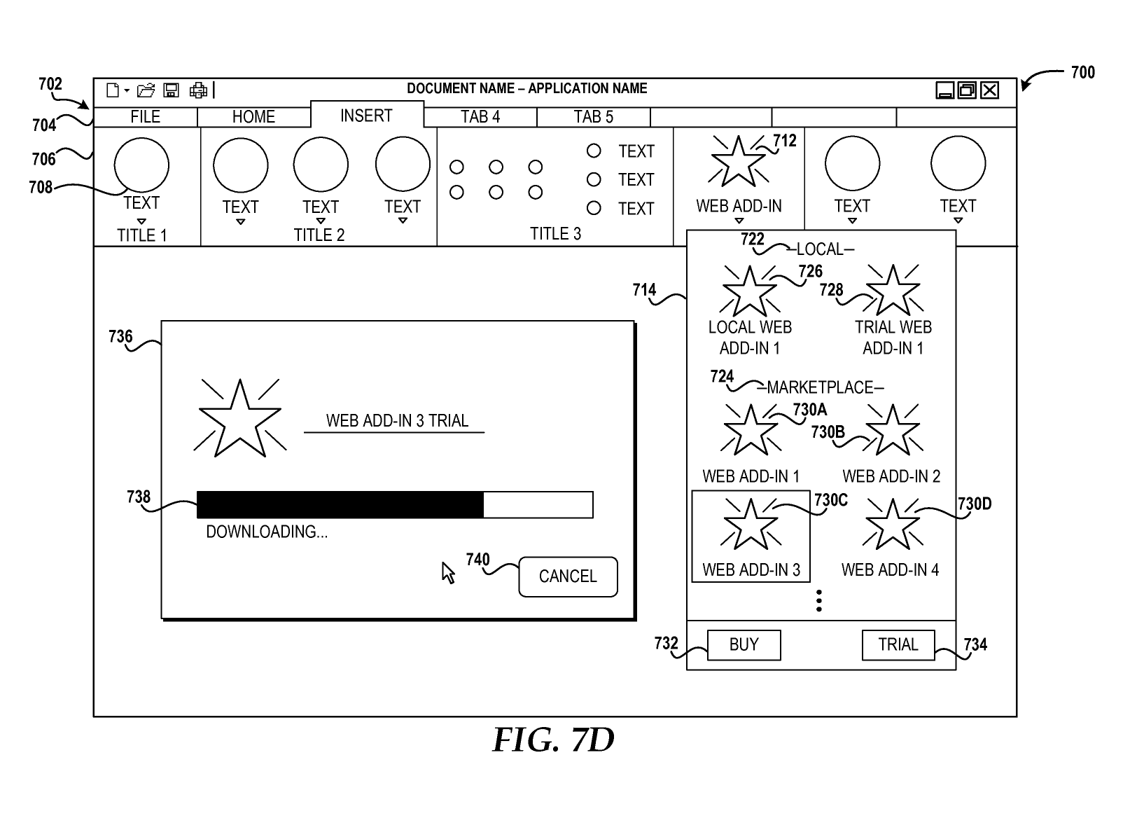

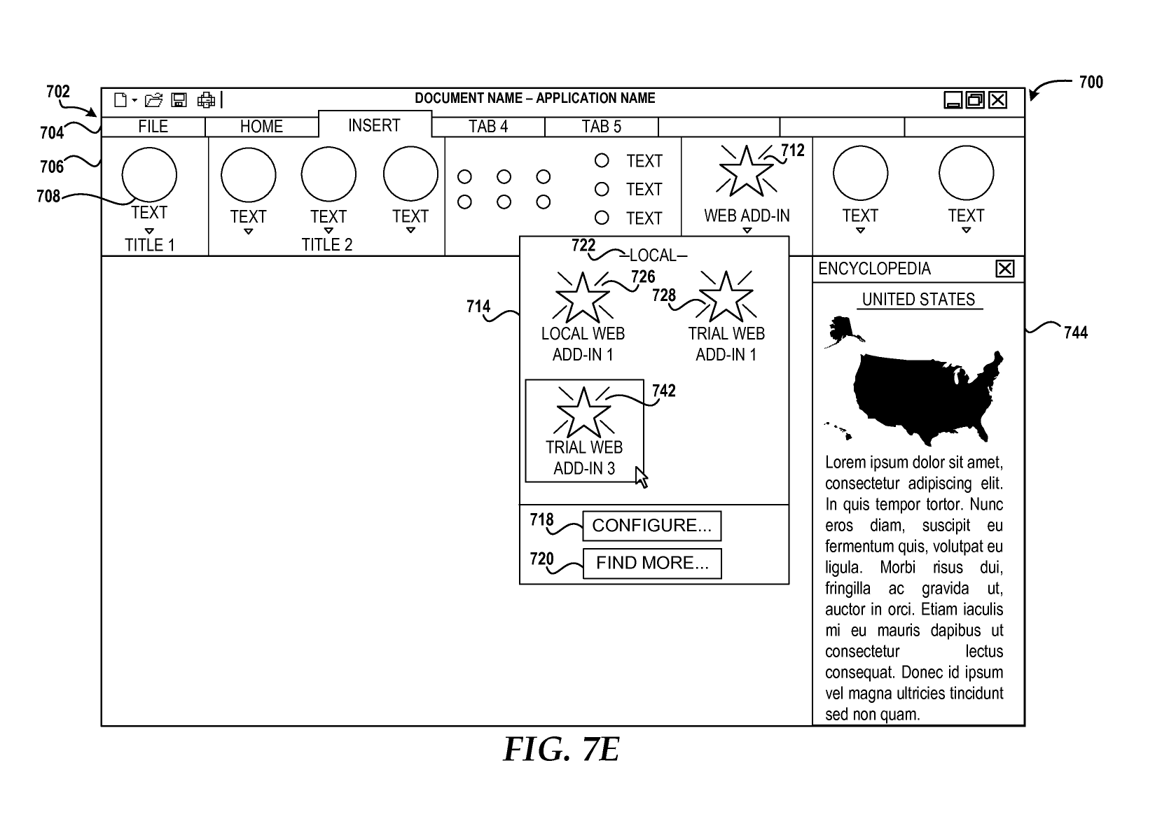

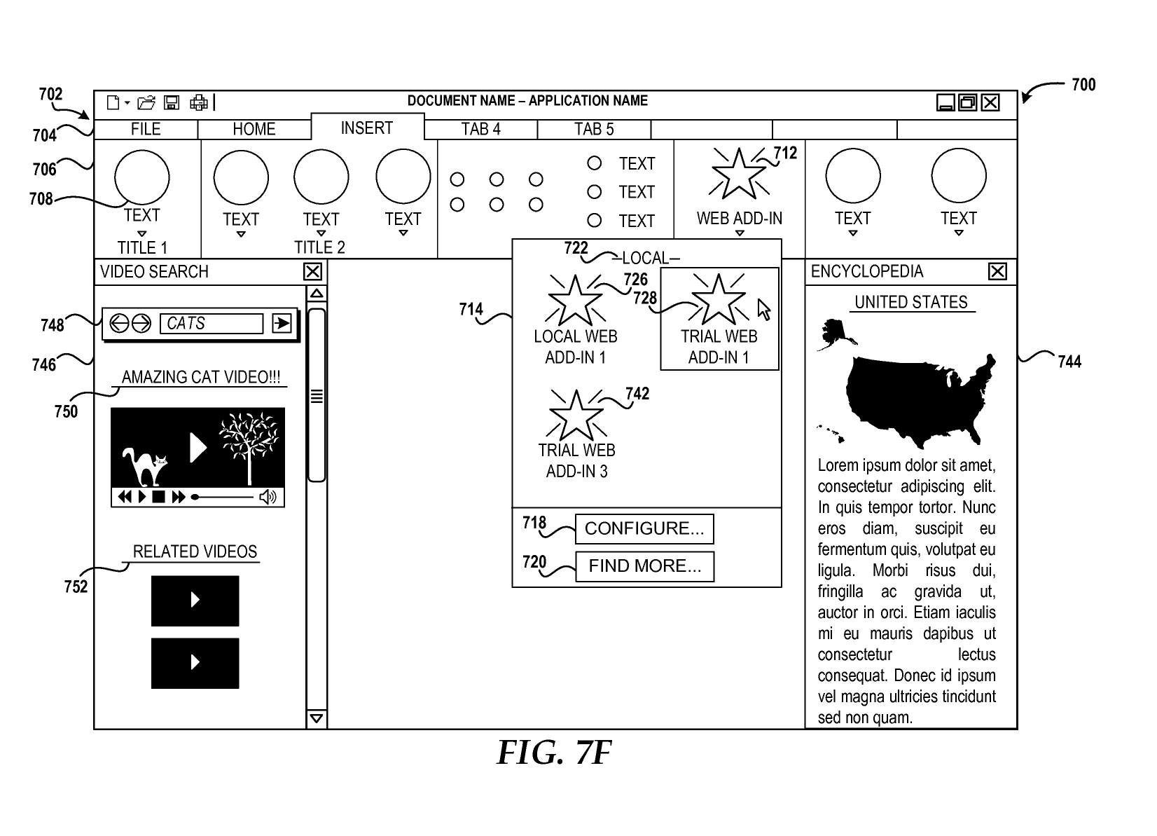

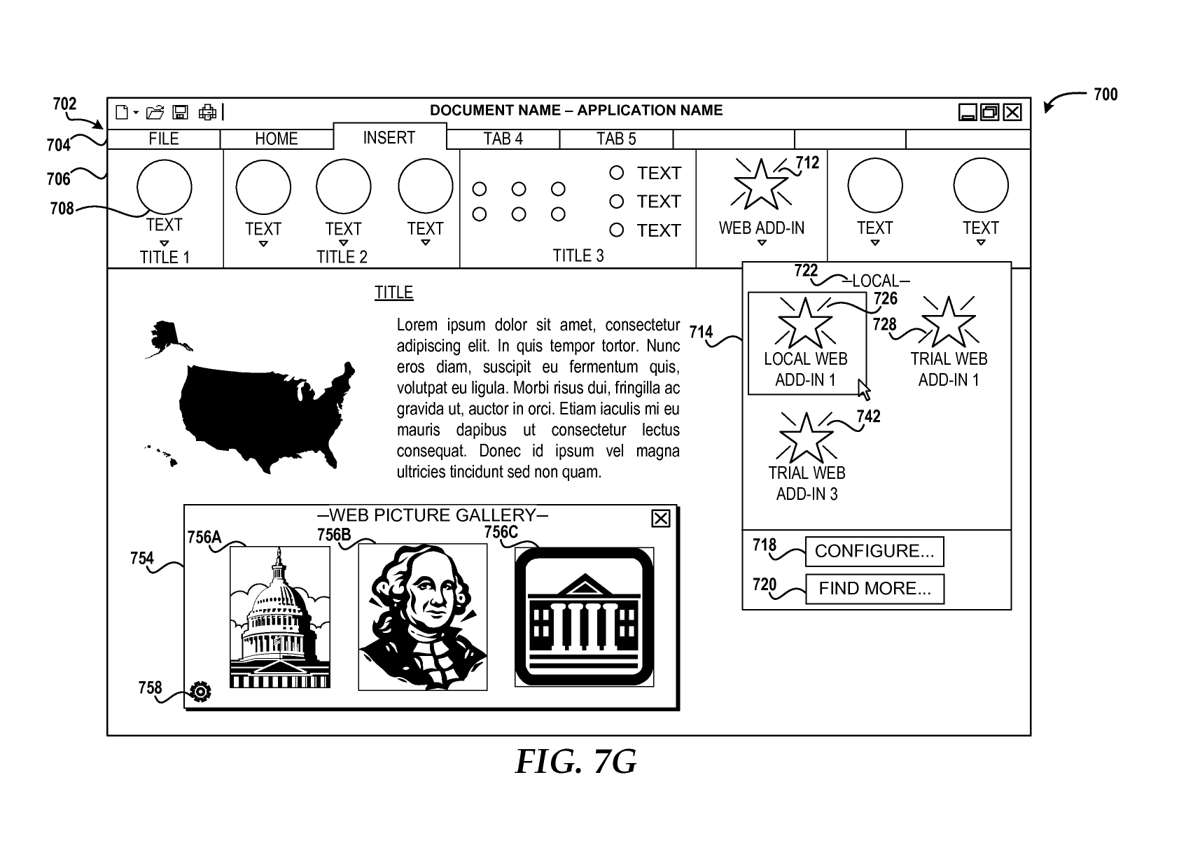

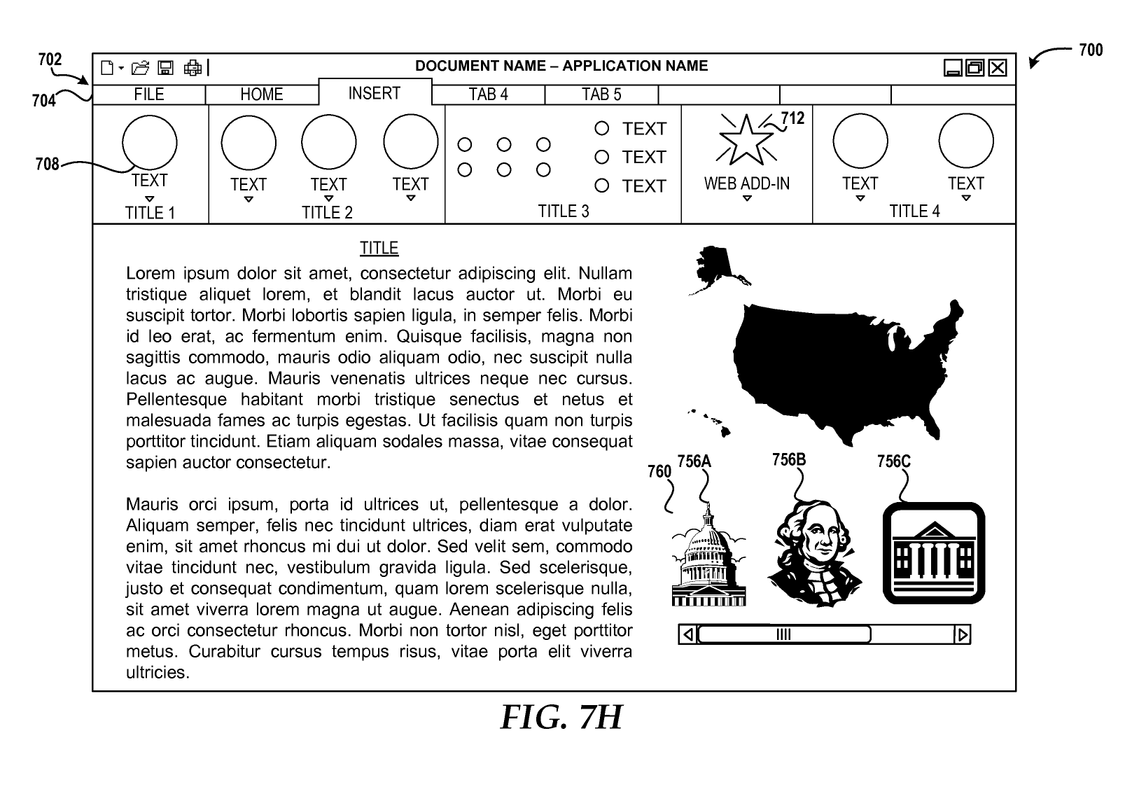

Turning now to FIGS. 7A-7H, user interface diagrams illustrating aspects of a user interface for a web add-in enabled application, such as the web add-in enabled application 118 will be described, according to various illustrative embodiments. Referring first to FIG. 7A, an illustrative user interface 700 provided by the web add-in enabled application is shown, according to one implementation disclosed herein. The illustrated user interface 700 includes a ribbon interface 702. The ribbon interface 702 is a user interface including a set of toolbars that are placed on tabs in a tab bar 704. In the illustrated embodiment, the tab bar 704 of the ribbon interface 702 includes tabs for FILE, HOME, INSERT, TAB 4, and TAB 5. Also in the illustrated embodiment, the INSERT TAB has been selected and various toolbars associated with various contents available for insertion are shown in a ribbon interface body 706. The illustrated toolbars in the ribbon interface body 706 each include a representative icon 708 for the type of feature provided by the toolbar. Some of the toolbars include an expand button 710, the selection of which causes available content for insertion to be displayed to the user. In the illustrated embodiment, the ribbon interface body 706 includes a web add-in insertion toolbar 712. Alternative and/or additional tabs and/or toolbars are contemplated and may vary based upon the type of tasks being performed by a user within the web add-in enabled application. The ribbon interface 702 may be customized by a user to include particular tabs and/or toolbars within tabs.

The illustrated user interface 700 shows the web add-in insertion toolbar 712 having been selected, thereby displaying a web add-in selection interface 714. The illustrated web add-in selection interface 714 includes a plurality of web add-in icons 716A, 716B, 716N, each of which is associated with a particular web add-in. The web add-in insertion toolbar 712 also includes a configure option 718 and a find more option 720. The configure option 718, when selected, can provide configuration options for the selected web add-in, such as the web add-in 1 716A in the illustrated embodiment. The configuration options can include design options such as font, color, emphasis, and the like. The configuration options can include any other options related to a web add-in. The find more option 720 may provide a link to the marketplace application 110 and/or to a marketplace web site hosted by or for the web add-in and marketplace server computer 106.

Turning now to FIG. 7B, the user interface 700 is shown with the web add-in toolbar 712 having been selected. The illustrated web add-in selection interface 714 now includes a local section 722 and a marketplace section 724. The local section 722 includes icons representative of web add-ins that are stored locally on a device or computer upon which the user interface 700 is operating. In some embodiments, the local section 722 includes all web add-ins available to a user including those purchased by a user of the device or computer and those that are available via a trial entitlement. In the illustrated embodiment, the local section 722 includes a local web add-in icon 726 and a trial web add-in icon 728. The marketplace section 724 includes icons representative of web add-ins that are available from a virtual marketplace, such as one provided by or for the web add-in and marketplace server computer 106. In the illustrated embodiment, the marketplace section 724 includes marketplace add-in icons 730A-730D.

The illustrated web add-in selection interface 714 also includes a buy option button 732 and a trial option button 734. Selection of the buy option button 732 initiates a transaction to purchase and download the selected web add-in and download. Selection of the trial option button 734 initiates a transaction to download the selected web add-in with a trial entitlement.

Turning now to FIG. 7C, the user interface 700 is shown with the web add-in toolbar 712 having been selected. In the illustrated embodiment, the trial option button 734 has been selected. In response to the trial option button 734 being selected, a trial version of the web add-in associated with the selected marketplace web add-in icon 730C is downloaded. FIG. 7D illustrates a download status interface 736, which includes a download status bar 738 for indicating a download status and a cancel button 740 for cancelling the download.

Turning now to FIG. 7E, the user interface 700 is shown with the web add-in toolbar 712 having been selected. In the illustrated embodiment, web add-in selection interface 714 includes a local trial web add-in icon 742 that is representative of the downloaded trial version of the web add-in downloaded in FIG. 7D. As illustrated, the local trial web add-in icon 742 has been selected. In response to the local trial web add-in icon 742 being selected, a task pane web add-in 744 is displayed on the right-hand side of the user interface 700. The illustrated task pane web add-in 744 adds a web-based encyclopedia to the user interface 700. The task pane web add-in 744 can alternatively or additionally include any other information that can be displayed in a web page, some examples of which are further described herein below. It is contemplated that a user can dock the task pane web add-in 744 in other locations within the user interface 700.

Turning now to FIG. 7F, the user interface 700 is shown with the web add-in toolbar 712 having been selected. In the illustrated embodiment, the task pane web add-in 744 is again displayed on the right-hand side of the user interface 700 and the trial web add-in icon 728 has been selected. In response to the trial web add-in icon 728 being selected, a second task pane web add-in 746 is displayed on the left-hand side of the user interface 700. The illustrated second task pane web add-in 746 adds a video search function to the user interface 700. In particular, the illustrated second task pane web add-in 746 includes a search bar 748 in which a user can input one or more search terms, a search results section 750 in which one or more search results for the search terms may be displayed, and a related videos section 752 in which one or more related videos may be displayed. It is contemplated that a user can dock the task pane web add-in 744 in other locations within the user interface 700.

Turning now to FIG. 7G, the user interface 700 is shown with the web add-in toolbar 712 having been selected. In the illustrated embodiment, the local web add-in icon 726 has been selected. In response to the local web add-in icon 726 being selected, a content web add-in 754 is displayed embedded within a document. In the illustrated embodiment, the content web add-in 754 is a picture gallery that includes a plurality of pictures 756A-756C, each of which may be selected by a user for insertion into the document. The content web add-in 754 also includes a configuration icon 758, which, when selected, provides configuration options for the content web add-in 754. Illustrative configuration options include, but are not limited to, a number of pictures to be displayed at a time, a source of the pictures, and a user account information for a pictures account (e.g., an online picture storage account) if the pictures account is a source of one or more of the pictures.

Turning now to FIG. 7H, an inline content web add-in 760 is shown. In the illustrated embodiment, the inline content web add-in 760 is a picture gallery that includes the plurality of pictures 756A-756C, each of which may be selected by a user for insertion into the document.

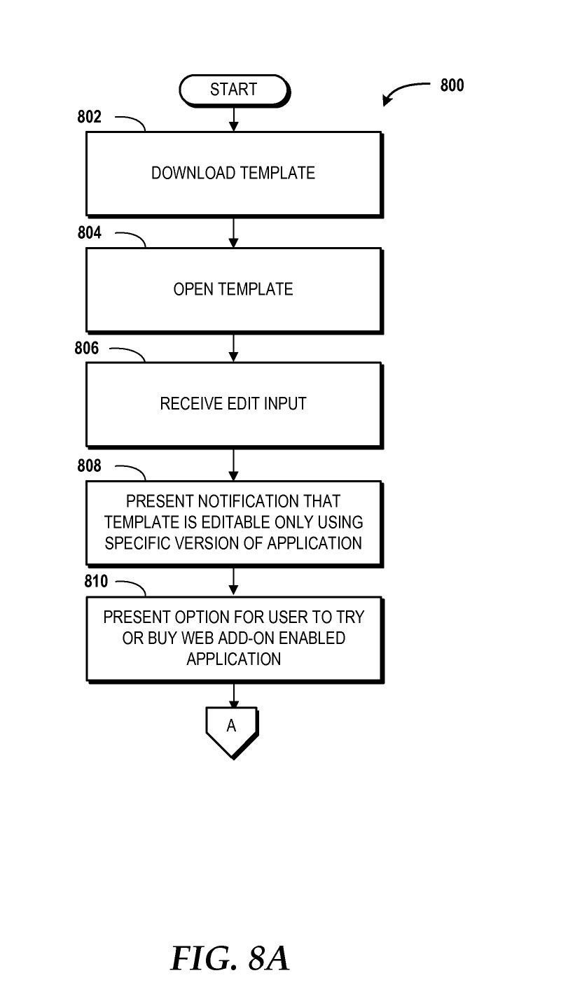

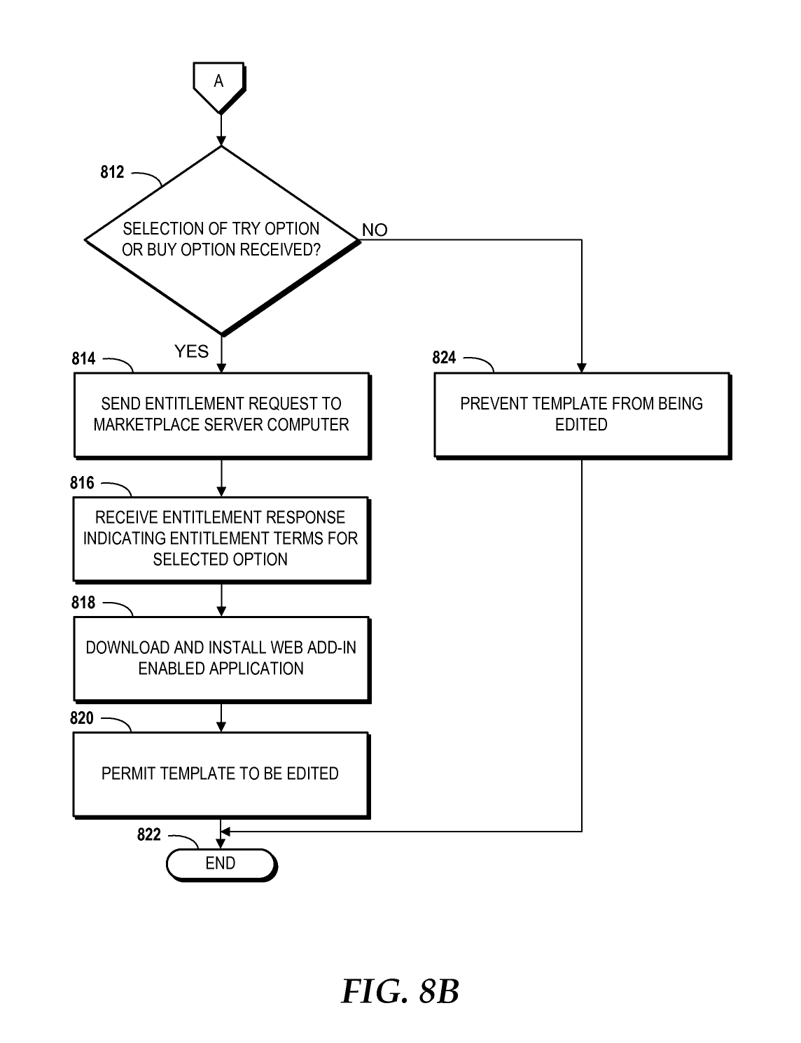

Turning now to FIGS. 8A and 8B, aspects of a method 800 for upgrading a web add-in viewer application, such as the web add-in viewer application 120, to a web add-in enabled application, such as the web add-in enabled application 118 will be described, according to an illustrative embodiment. Although the method 800 is described in context of a document template, the method 800 is equally applicable to a document.

The method 800 begins and proceeds to operation 802, wherein the user interface device A 102A downloads a template. From operation 802, the method 800 proceeds to operation 804, wherein the user interface device A 102A opens the template using the web add-in viewer application 120. The method 800 then proceeds to operation 806, wherein the user interface device A 102A receives an edit input that attempts to edit the template. Alternatively, the user interface device A 102A may receive an attempt to manipulate or use one or more of the web add-ins that the template or document contains. In response to the edit input, the method proceeds to operation 808, wherein the user interface device A 102A presents a notification to the user that the template is editable only using a specific version of an application and the web add-in viewer application 120 would need to be upgraded for the template to be editable. The method 800 then proceeds to operation 810, wherein the user device A 102A presents an option for the user to try or buy the web add-in enabled application 118.

Alternatively, in some embodiments, the static snapshot, which is shown before the user attempts the edit, is different within applications that support editing web add-ins versus applications that support only viewing web add-ins. In the latter, an omnipresent watermark, for example, may be used to inform users that the web add-in is a trial version (i.e., includes a trial entitlement) and to click or otherwise select an upgrade button or other user interface element to upgrade the web add-in viewer to be a web add-in editor.

Turning now to FIG. 8B, the method 800 proceeds to operation 812, wherein the user device A 102A determines if a selection of the try option or the buy option was received. If, at operation 812, the user device A 102A determines that either the try option or the buy option was selected, the method 800 proceeds to operation 814, wherein the user device A 102A sends an entitlement request to the web add-in and marketplace server computer 106. The entitlement request includes a request for a trial entitlement for the web add-in enabled application 118 or a purchase entitlement depending upon whether the trial option or the buy option was selected. In response to receiving the entitlement request, the web add-in and marketplace server computer 106 and, particularly, the entitlement management application 118 updates a user account for the user of the user device A 102A to include an entitlement in accordance with the selected option. If the buy option was selected, the transaction application 136 can arrange for payment for the entitlement either by a payment account on record or by prompting the user to enter payment details from the user device A 102A. The terms of the entitlement are obtained from the entitlement data store 144.

It should be understood that, although the web add-in and marketplace server computer 106 is described above as selling individual web add-ins and an application that can edit web add-ins (e.g., the web add-in enabled application 118) via a virtual marketplace, the distribution of web add-ins and applications that can edit web add-ins may be distributed using different software distribution models. For example, web add-in enabled applications may be offered for purchase embodied on some form of a physical media, such as one or more DVDs, or could be offered as a downloadable application from an e-tailer.

From operation 814, the method 800 proceeds to operation 816, wherein the user device A 102A receives an entitlement response from the web add-in and marketplace server computer 106. The entitlement response includes the terms of the entitlement obtained from an entitlement data store. In some embodiments, the entitlement data store is configured to include entitlements for web add-in enabled applications. In some embodiments, the entitlement data store is the entitlement data store 144. In these embodiments, the entitlement data store 144 is configured to store entitlements for web add-in enabled applications and web add-ins. The method 800 then proceeds to operation 818, wherein the user device A 102A downloads and installs the web add-in enabled application 118. In other implementations, the user device A 102A receives an updated license from an entitlement server and the web add-in viewer application 120 then operates functionally as the web-add in enabled application 118. In other words, both the web add-in enabled application 118 and the web add-in viewer application 120 are the same application program, and only a licensing state defines which mode the application program operates in. At operation 820, the user device A 102A, using the web add-in enabled application 118, permits the template to be edited. The method 800 then proceeds to operation 822, wherein the method 800 ends.

If, at operation 812, the user device A 102A determines that neither the try option nor the buy option was selected, the method 800 proceeds to operation 824, wherein the user device A 102, using the web add-in viewer application 120, prevents the template from being edited. From operation 824, the method 800 proceeds to operation 822, wherein the method 800 ends.

In some embodiments, if a user purchases a web add-in enabled application, the user receives an entitlement to the web add-ins in a document or template without having to separately purchase the web add-ins. In some embodiments, the developer who created a web add-in is paid a commission from the proceeds of the sale of the web add-in enabled application.

In some embodiments, the web add-in enabled application and the web add-in viewer application are the same binaries, but the licensing state defines whether a user can edit or just view a web add-in. In other words, a user could pay $2 for a web add-in viewer application or $200 for a web add-in enabled application that permits editing of web add-ins, in which case the binaries for the web add-in viewer application and the web add-in enabled application may be the same, but the licensing states of the binaries may define to what features a user has access.

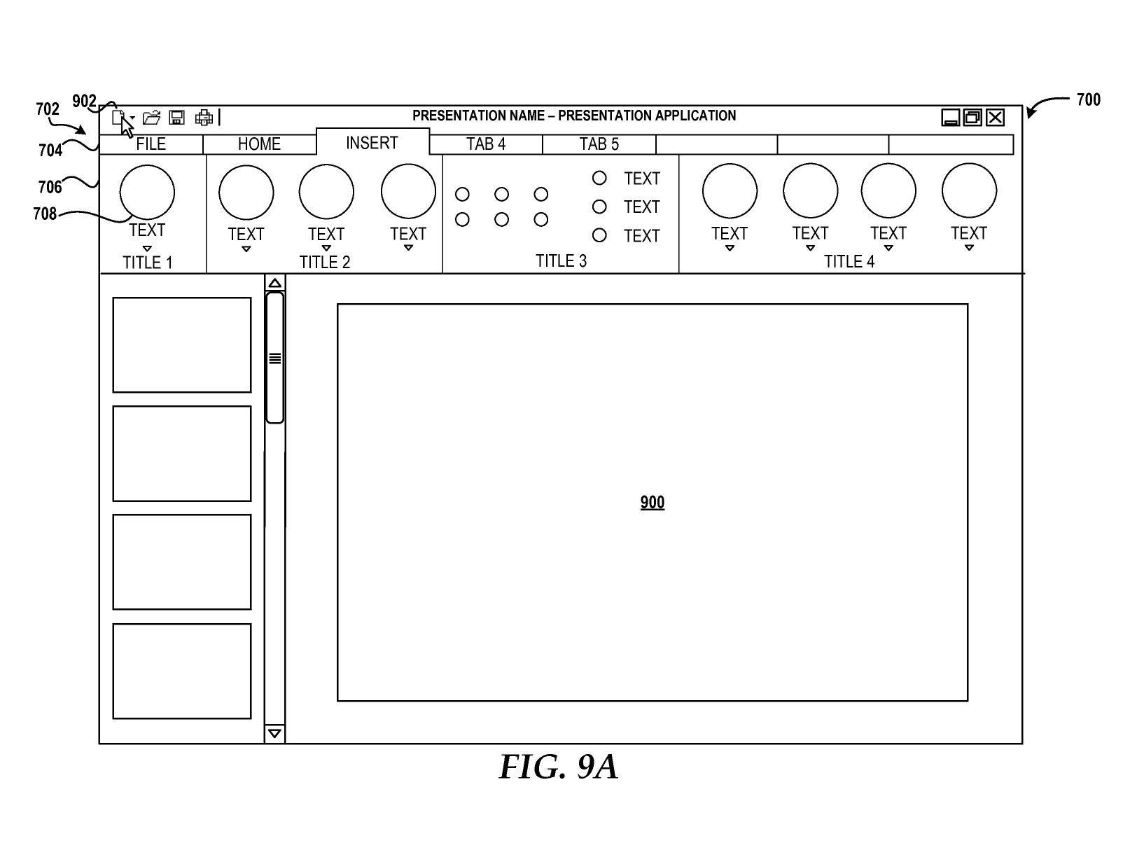

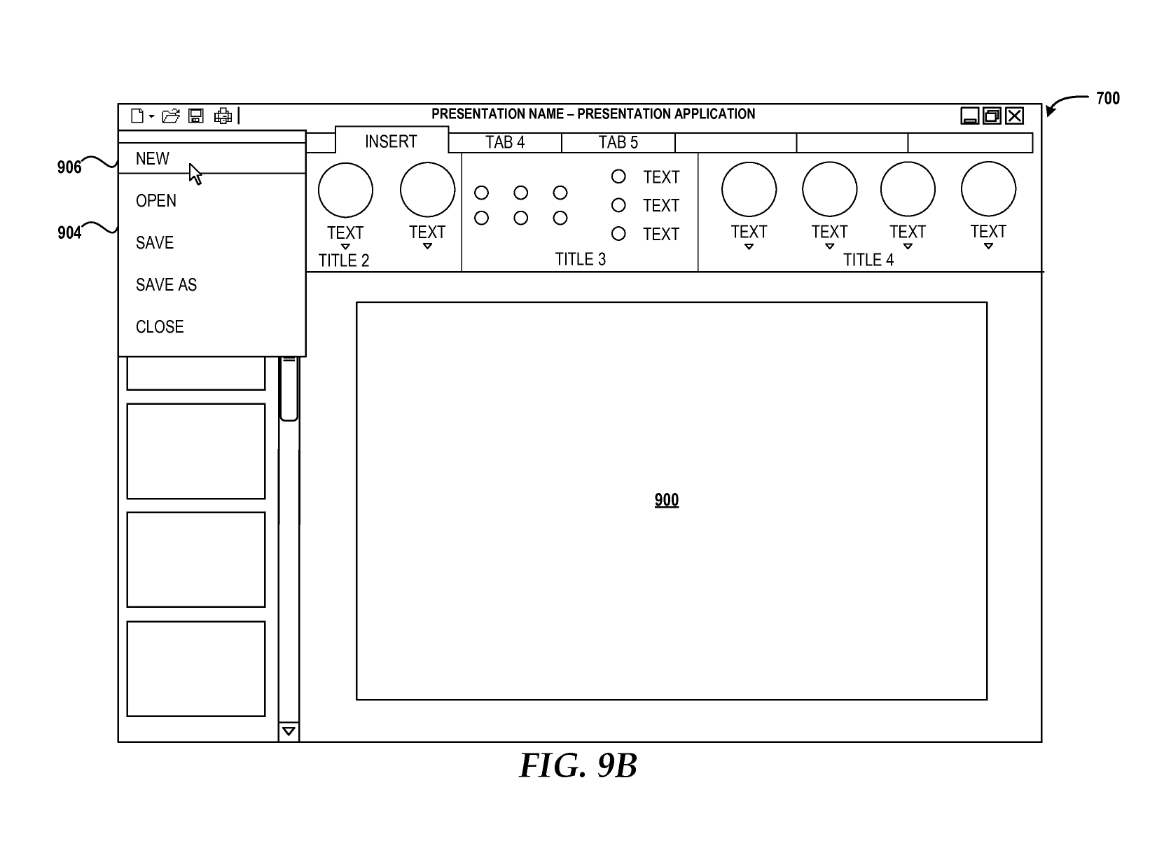

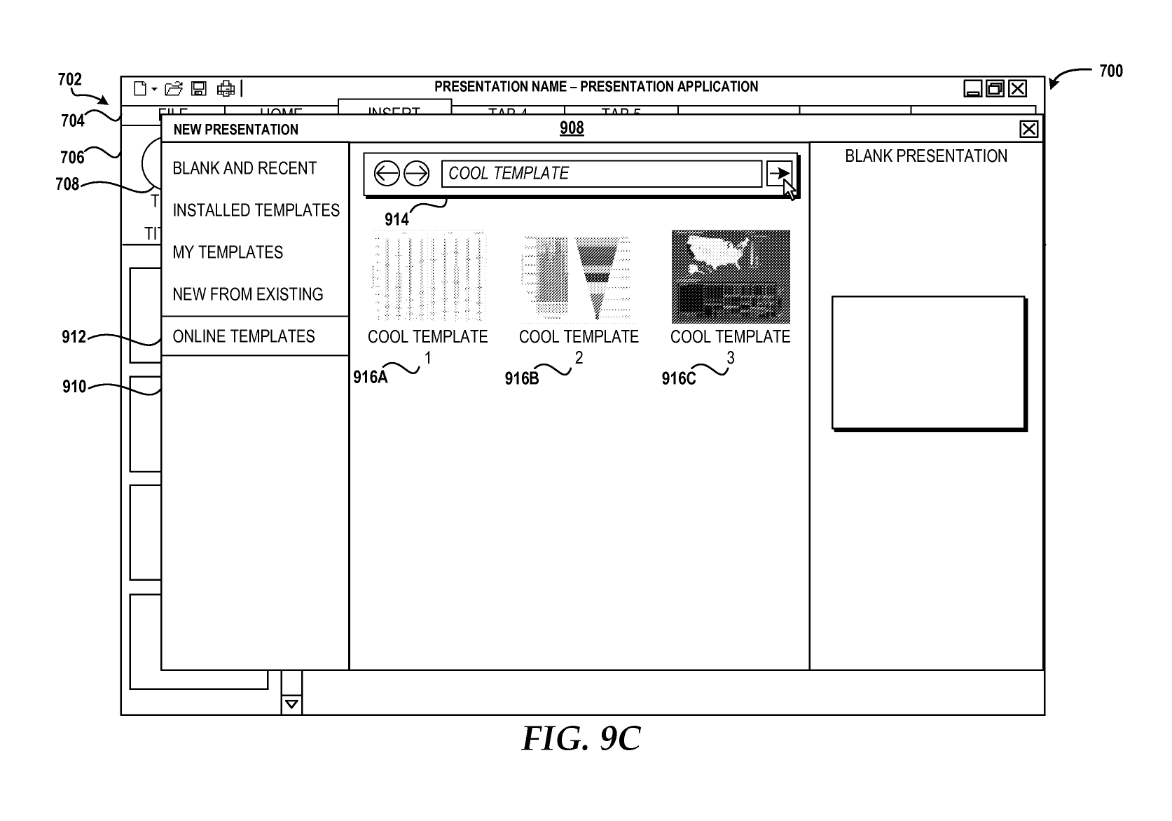

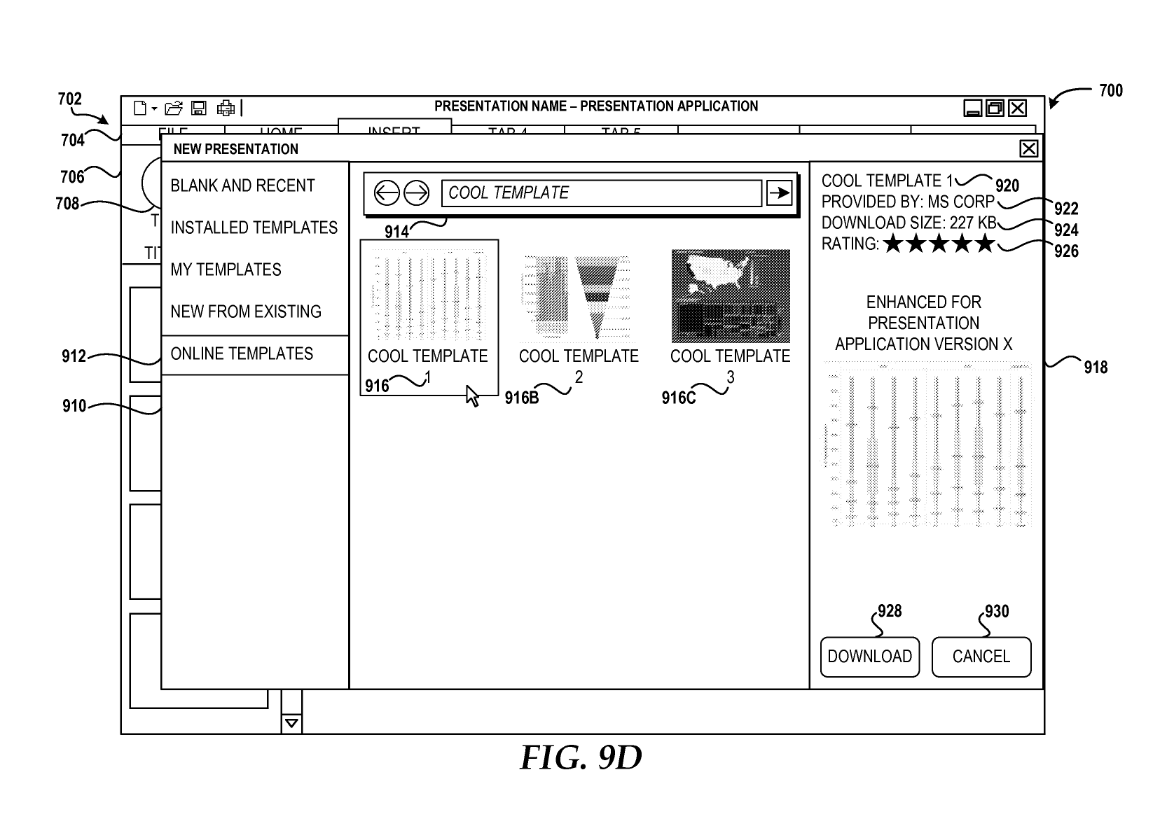

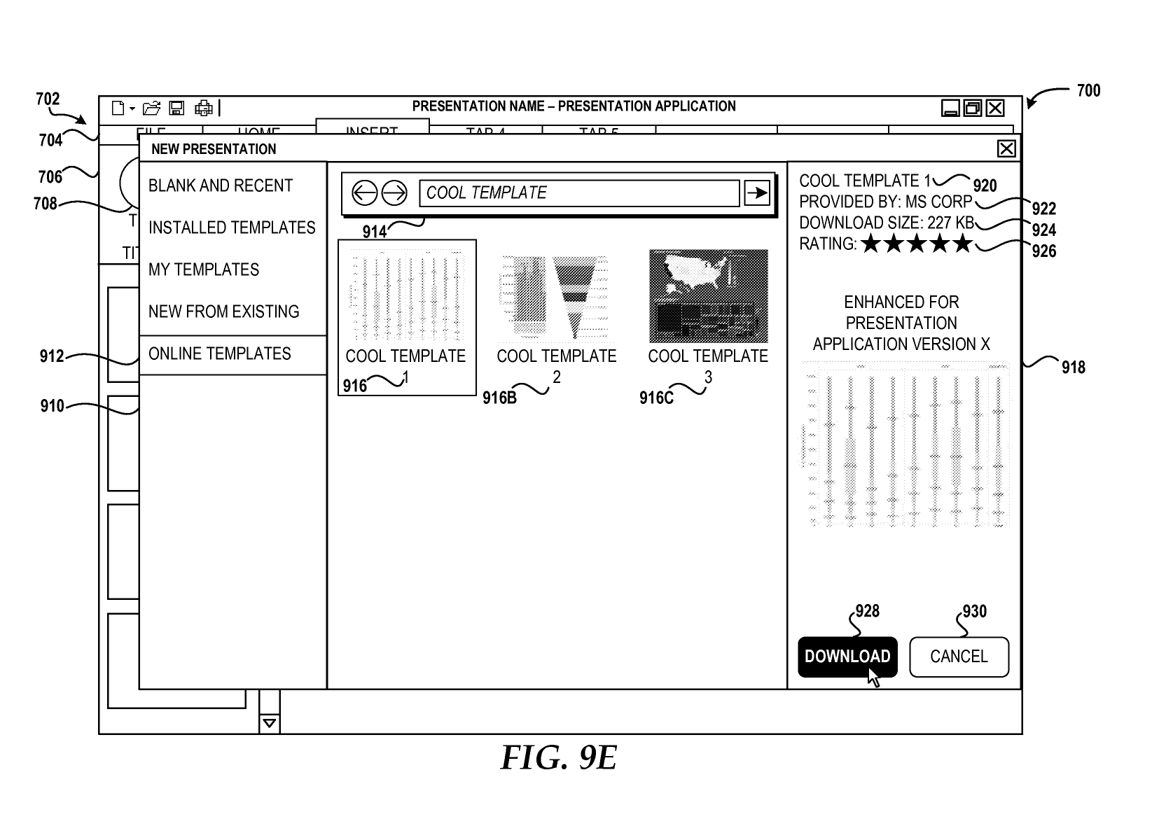

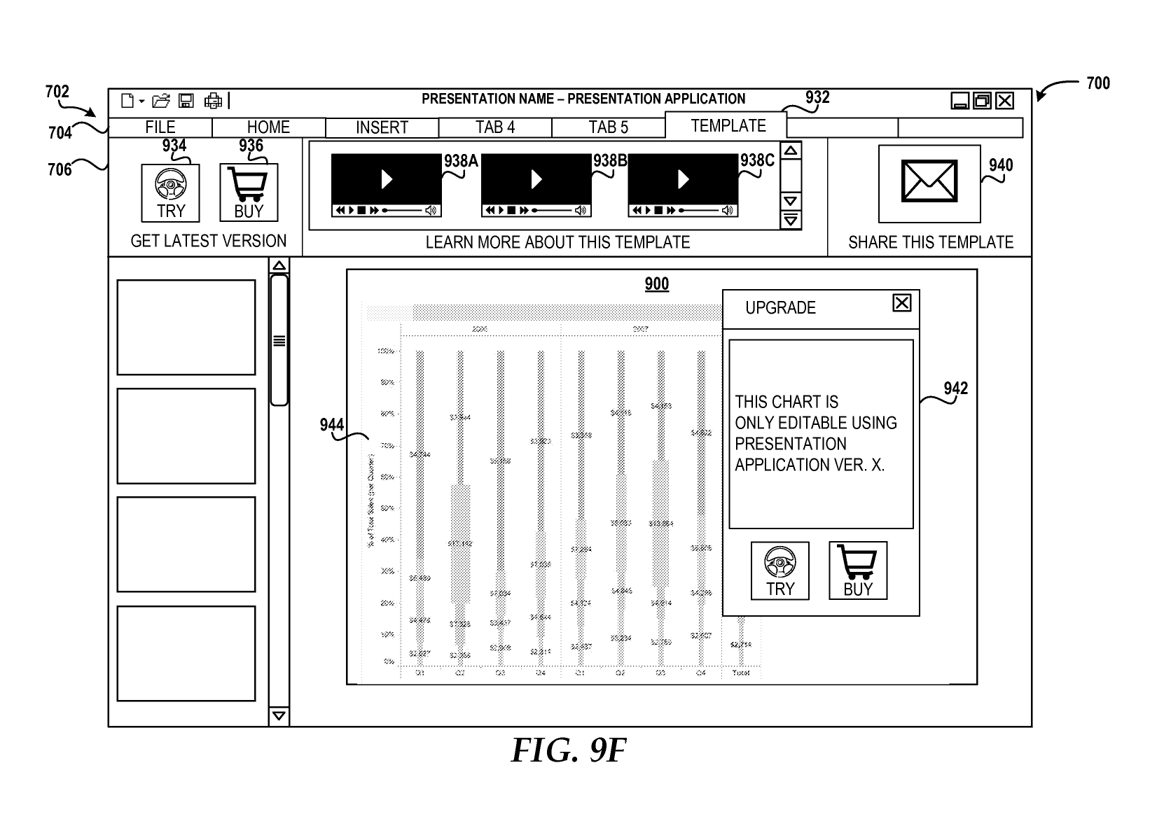

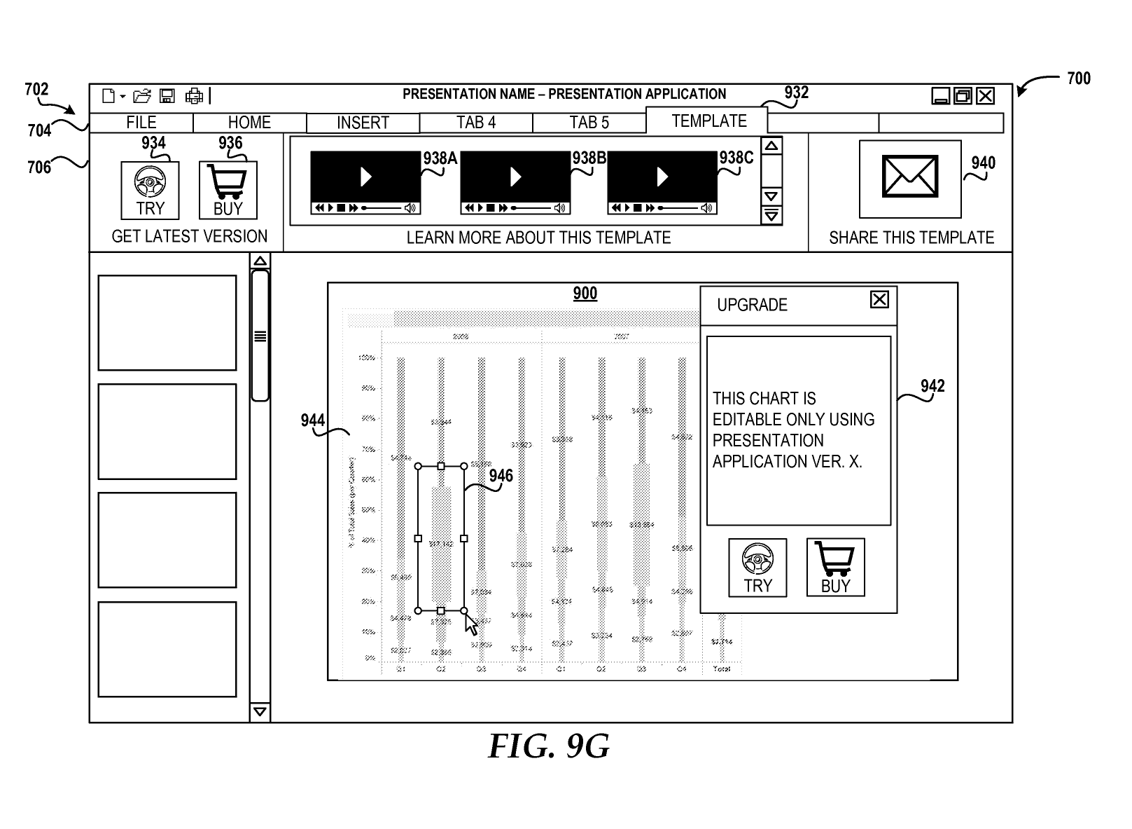

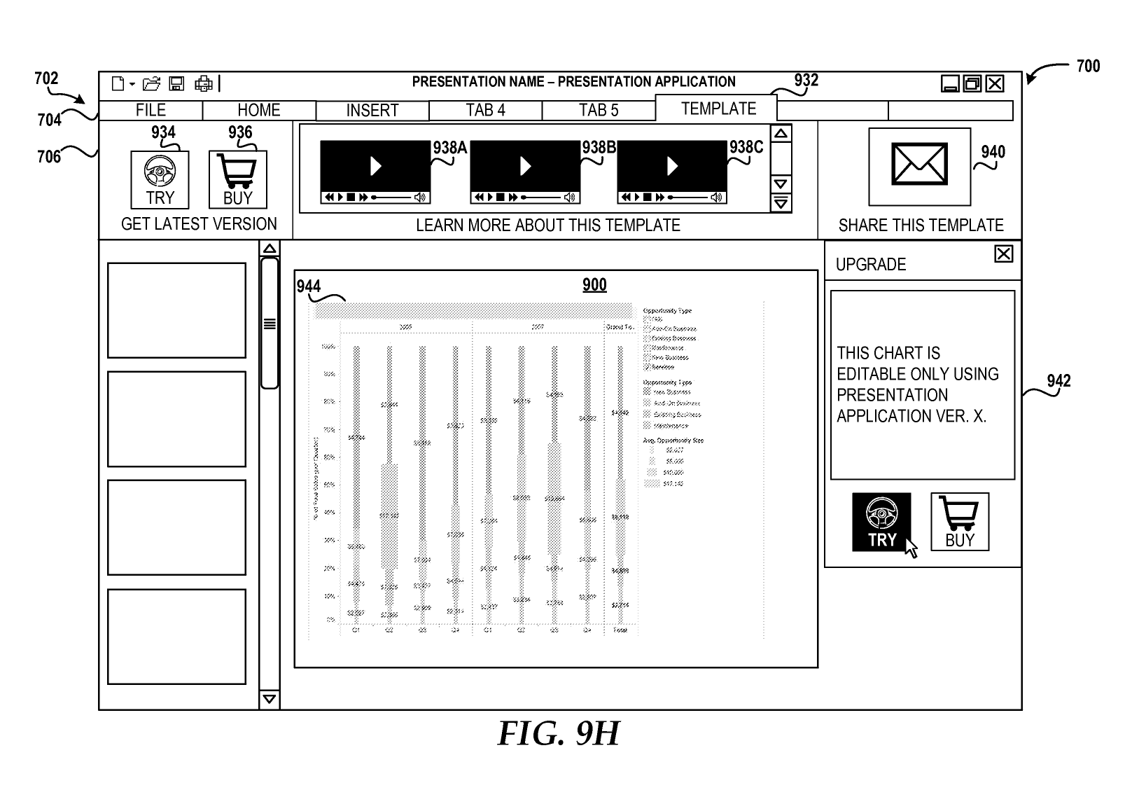

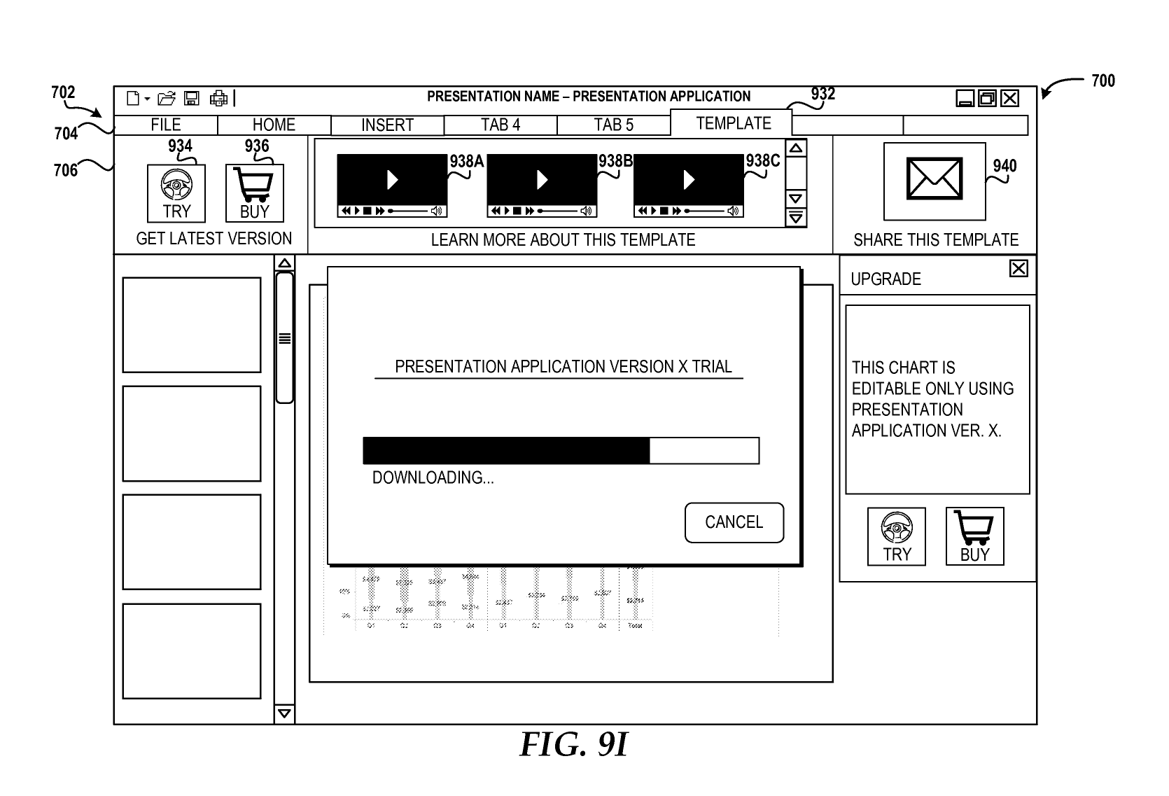

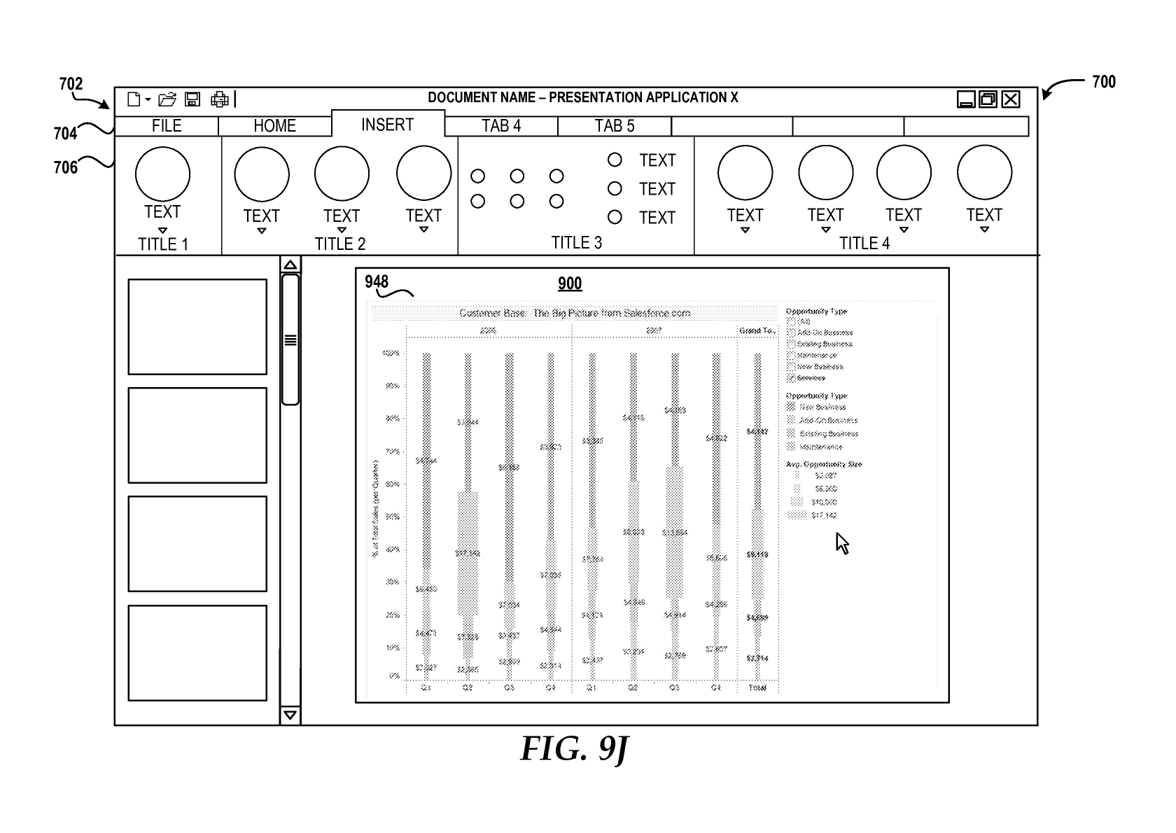

Turning to FIGS. 9A-9J, the user interface 700 first introduced in FIG. 7A is illustrated. The basic layout of the user interface 700 is the same as described above. In the illustrated embodiment, the user interface 700 is particular to a presentation application merely for purposes of illustration and not limitation. The illustrated user interface 700 includes a presentation canvas 900 upon which a user can insert content create a presentation, such as a MICROSOFT POWERPOINT presentation. The illustrated user interface 700 also include a presentation selection option 902, the selection of which triggers a document drop-down menu 904 to be displayed in the user interface 700, as illustrated in FIG. 9B. In the illustrated embodiment, a new presentation option 906 has been selected. In response to the new presentation option 906 being selected, a new presentation interface 908 is displayed, as illustrated in FIG. 9C. The new presentation interface 908 includes a new presentation type menu 910 through which various types of presentations may be selected. In the illustrated embodiment, an online templates option 912 has been selected from the new presentation type menu 910. In response to the online templates option 912 being selected, a template search bar 914 is displayed. The template search bar 914 facilitates searching for templates by one or more search terms. In the illustrated embodiment, a user has searched for “COOL TEMPLATE” and a plurality of search results 916A, 916B, 916C matching these search terms are displayed.

Turning to FIG. 9D, the search result 916A has been selected and, in response thereto, a template details interface 918 is displayed in the user interface 700. The illustrated template details interface 918 includes a template name field 920, a template source field 922, a download size field 924, a rating field 926, a download option button 928, and a cancel option button 930. Turning to FIG. 9E, the download option button 928 has been selected. In response to the download option button 928 being selected, the template associated with the search result 916A is downloaded to the user device A 102A.

Turning now to FIG. 9F, the template associated with the search result 916A has been downloaded to the user device A 102A. In the illustrated embodiment, the template creates a template tab 932 in the tab bar 704. Moreover, the template tab 932 has been selected and, in response, the ribbon interface body 706 is populated with a try button 934, a buy button 936, a plurality of template teaching videos 938A-938C, and a share template button 940. As also shown in the illustrated embodiment, the template is not compatible with the web add-in viewer application 120 and, as such, the user interface 700 includes an upgrade notification 942 to notify the user that a chart 944 included in the template is editable with a particular application version, such as the web add-in enabled application 118, and to provide options to try or buy the particular application version.

Turning now to FIG. 9G, a user has selected a portion 946 of the chart 944. The chart 944, however, is not editable with the web add-in viewer application 120, so the user decides to try the upgraded application to edit the chart 944, as shown in FIG. 9H. The upgraded application is then downloaded as shown in FIG. 9I. Once downloaded and installed, the upgraded application displays an editable chart 948, as shown in FIG. 9J.

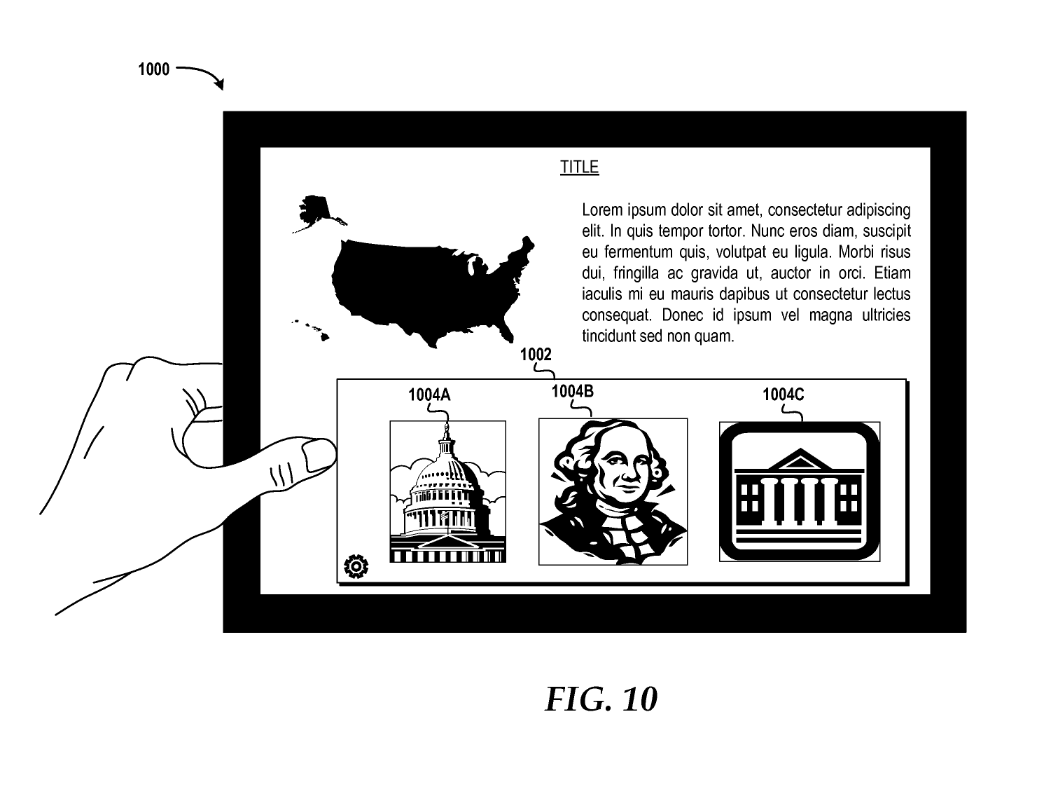

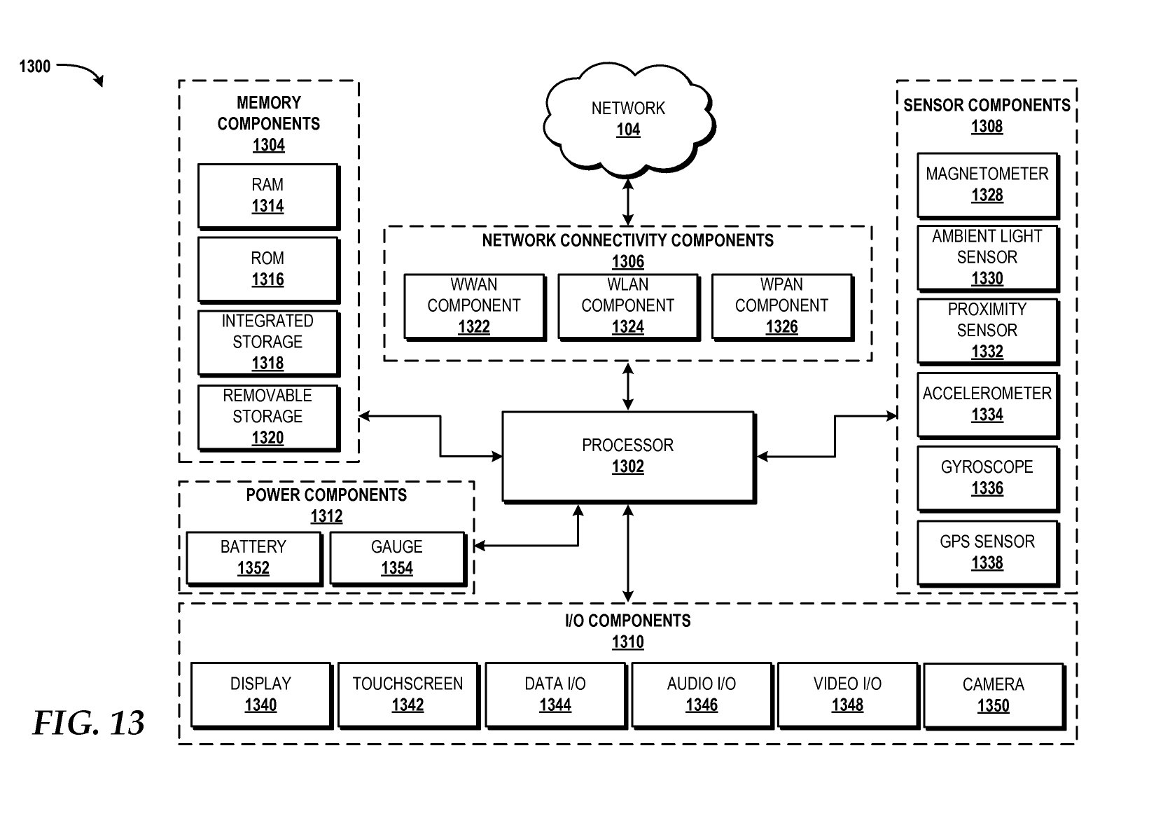

Turning now to FIG. 10, an illustrative tablet device 1000 with a touch-enabled web add-in 1002 is shown. The tablet device 1000 may utilize all or a portion of the computing device architecture described herein below with reference to FIG. 13. In the illustrated embodiment, the touch-enabled web add-in 1002 includes a plurality of pictures 1004A-1004C, each of which may be a selection for insertion into a document via a single or multi-touch gesture. Any of the above described web add-ins may be embodied in a touch centric format so as to be deployed on touch-enabled devices such as the illustrated tablet device 1000 and/or touch-enabled smart phones.

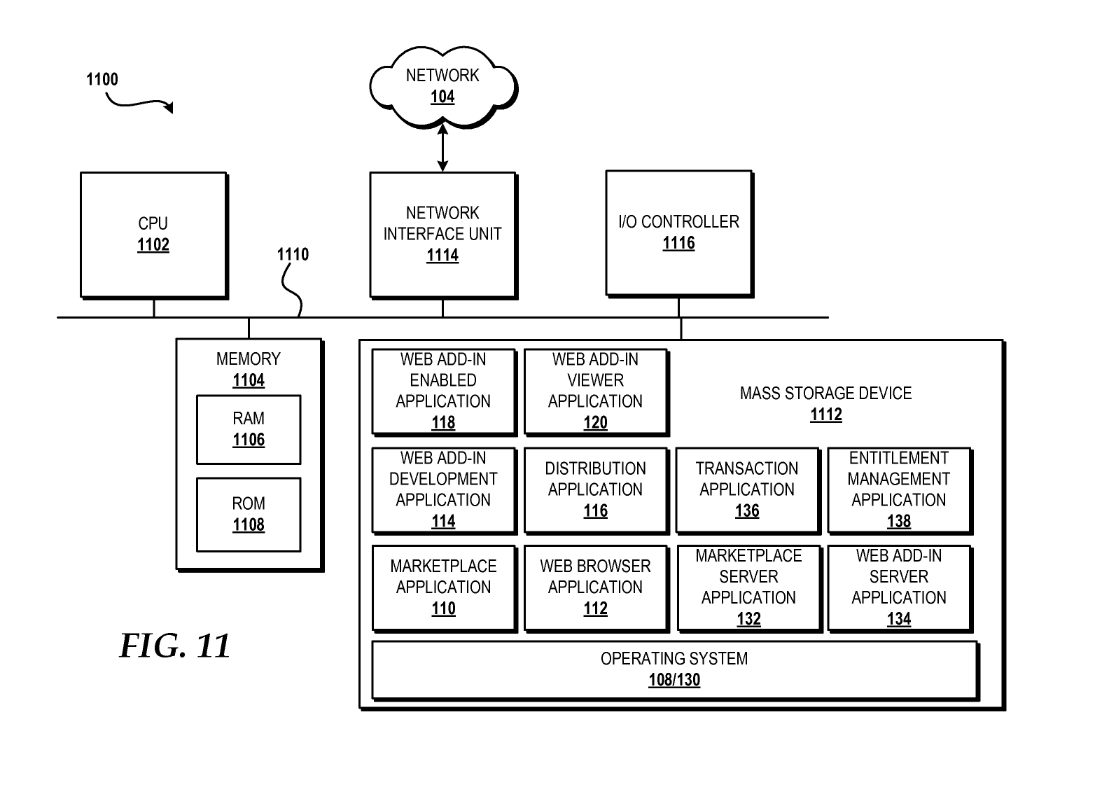

FIG. 11 illustrates an illustrative computer architecture 1100 for a device capable of executing the software components described herein for distributing web-based software application extensions within documents, among other aspects. Thus, the computer architecture 1100 illustrated in FIG. 11 illustrates an architecture for a server computer, mobile phone, a PDA, a smart phone, a desktop computer, a netbook computer, a tablet computer, and/or a laptop computer. The computer architecture 1100 may be utilized to execute any aspects of the software components presented herein.

In some embodiments, the user device A 102A, the user device 102B, the user device 102N, and/or the web add-in and marketplace server computer 106 are configured in accordance with the computer architecture 1100. As such, software components of the user device A 102A and the web add-in and marketplace server computer 106 are shown together within the computer architecture 1100 for ease of illustration. It should be understood, however, that these software components may be and are likely to be implemented in separate computers, such as in a client/server configuration, or as standalone software components executing on one or both of the user device A 102A and the web add-in and marketplace server computer 106. The user device 102B and the user device 102N may also include similar software components. It also should be understood that, although the data stores 122, 124, 126, 128, 140, 142, 144, 146 described above with reference to FIG. 1 are not illustrated, one or more of the data stores 122, 124, 126, 128, 140, 142, 144, 146 may also be included in the computer architecture 1100 and/or the computer architecture 1100 may be in communication with one or more of the data stores 122, 124, 126, 128, 140, 142, 144, 146.

The computer architecture 1100 illustrated in FIG. 11 includes a central processing unit 1102 (“CPU”), a system memory 1104, including a random access memory 1106 (“RAM”) and a read-only memory (“ROM”) 1108, and a system bus 1110 that couples the memory 1104 to the CPU 1102. A basic input/output system containing the basic routines that help to transfer information between elements within the computer architecture 1100, such as during startup, is stored in the ROM 1108. The computer architecture 1100 further includes a mass storage device 1112 for storing the operating system 108 and the server operating system 130, and one or more application programs including, but not limited to, the marketplace application 110, the web browser application 112, the web add-in development application 114, the distribution application 116, the web add-in enabled application 118, the web add-in viewer application 120, the marketplace server application 132, the web add-in server application 134, the transaction application 136, and the entitlement management application 138.

The mass storage device 1112 is connected to the CPU 1102 through a mass storage controller (not shown) connected to the bus 1110. The mass storage device 1112 and its associated computer-readable media provide non-volatile storage for the computer architecture 1100. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 1100.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1100. For purposes the claims, the phrase “computer storage medium” and variations thereof, does not include waves, signals, and/or other transitory and/or intangible communication media, per se.

According to various embodiments, the computer architecture 1100 may operate in a networked environment using logical connections to remote computers through the network 104 and/or another network (not shown). The computer architecture 1100 may connect to the network 104 through a network interface unit 1114 connected to the bus 1110. It should be appreciated that the network interface unit 1114 also may be utilized to connect to other types of networks and remote computer systems. The computer architecture 1100 also may include an input/output controller 1116 for receiving and processing input from a number of other devices, including a keyboard, mouse, or electronic stylus (not shown in FIG. 11). Similarly, the input/output controller 1116 may provide output to a display screen, a printer, or other type of output device (also not shown in FIG. 11).

It should be appreciated that the software components described herein may, when loaded into the CPU 1102 and executed, transform the CPU 1102 and the overall computer architecture 1100 from a general-purpose computing system into a special-purpose computing system customized to facilitate the functionality presented herein. The CPU 1102 may be constructed from any number of transistors or other discrete circuit elements, which may individually or collectively assume any number of states. More specifically, the CPU 1102 may operate as a finite-state machine, in response to executable instructions contained within the software modules disclosed herein. These computer-executable instructions may transform the CPU 1102 by specifying how the CPU 1102 transitions between states, thereby transforming the transistors or other discrete hardware elements constituting the CPU 1102.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1100 in order to store and execute the software components presented herein. It also should be appreciated that the computer architecture 1100 may include other types of computing devices, including hand-held computers, embedded computer systems, personal digital assistants, and other types of computing devices known to those skilled in the art. It is also contemplated that the computer architecture 1100 may not include all of the components shown in FIG. 11, may include other components that are not explicitly shown in FIG. 11, or may utilize an architecture completely different than that shown in FIG. 11.

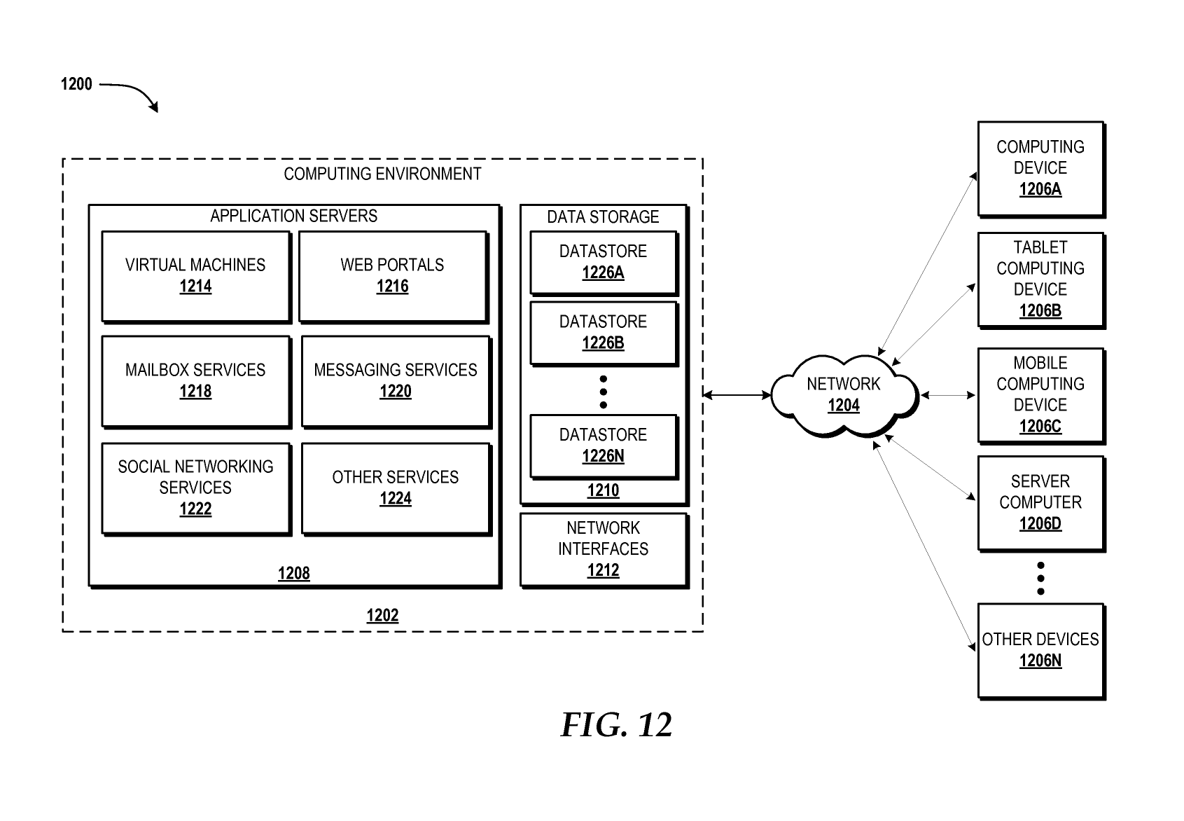

FIG. 12 illustrates an illustrative distributed computing environment 1200 capable of executing the software components described herein for distributing web-based software application extensions within documents, among other aspects. Thus, the distributed computing environment 1200 illustrated in FIG. 12 can be utilized to execute any aspects of the software components presented herein. For example, the distributed computing environment 1200 can be utilized to execute aspects of the marketplace application 110, the web browser application 112, the web add-in development application 114, the distribution application 116, the web add-in enabled application 118, the web add-in viewer application 120, the marketplace server application 132, the web add-in server application 134, the transaction application 136, the entitlement management application 138, and/or other software components described herein.

According to various implementations, the distributed computing environment 1200 includes a computing environment 1202 operating on, in communication with, or as part of the network 1204. The network 1204 may be or may include the network 104, described above with reference to FIG. 1. The network 1204 also can include various access networks. One or more client devices 1206A-1206N (hereinafter referred to collectively and/or generically as “clients 1206”) can communicate with the computing environment 1202 via the network 1204 and/or other connections (not illustrated in FIG. 12). In the illustrated embodiment, the clients 1206 include a computing device 1206A such as a laptop computer, a desktop computer, or other computing device; a slate or tablet computing device (“tablet computing device”) 1206B; a mobile computing device 1206C such as a mobile telephone, a smart phone, or other mobile computing device; a server computer 1206D; and/or other devices 1206N. It should be understood that any number of clients 1206 can communicate with the computing environment 1202. Two example computing architectures for the clients 1206 are illustrated and described herein with reference to FIGS. 11 and 13. It should be understood that the illustrated clients 1206 and computing architectures illustrated and described herein are illustrative, and should not be construed as being limited in any way.

In the illustrated embodiment, the computing environment 1202 includes application servers 1208, data storage 1210, and one or more network interfaces 1212. According to various implementations, the functionality of the application servers 1208 can be provided by one or more server computers that are executing as part of, or in communication with, the network 1204. The application servers 1208 can host various services, virtual machines, portals, and/or other resources. In the illustrated embodiment, the application servers 1208 host one or more virtual machines 1214 for hosting applications or other functionality. According to various implementations, the virtual machines 1214 host one or more applications and/or software modules for providing the functionality described herein for distributing web-based software application extensions within documents, among other aspects. It should be understood that this embodiment is illustrative, and should not be construed as being limiting in any way. The application servers 1208 also host or provide access to one or more Web portals, link pages, Web sites, and/or other information (“Web portals”) 1216.

According to various implementations, the application servers 1208 also include one or more mailbox services 1218 and one or more messaging services 1220. The mailbox services 1218 can include electronic mail (“email”) services. The mailbox services 1218 also can include various personal information management (“PIM”) services including, but not limited to, calendar services, contact management services, collaboration services, and/or other services. The messaging services 1220 can include, but are not limited to, instant messaging services, chat services, forum services, and/or other communication services.

The application servers 1208 also can include one or more social networking services 1222. The social networking services 1222 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 1222 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 1222 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 1222 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE+ service, and/or other services. It should be appreciated that the above lists of services are not exhaustive and that numerous additional and/or alternative social networking services 1222 are not mentioned herein for the sake of brevity. As such, the above embodiments are illustrative, and should not be construed as being limited in any way.

As shown in FIG. 12, the application servers 1208 also can host other services, applications, portals, and/or other resources (“other resources”) 1224. The other resources 1224 can include, but are not limited to, the presentation application program. It thus can be appreciated that the computing environment 1202 can provide integration of the concepts and technologies disclosed herein provided herein with various mailbox, messaging, social networking, and/or other services or resources.

As mentioned above, the computing environment 1202 can include the data storage 1210. According to various implementations, the functionality of the data storage 1210 is provided by one or more databases operating on, or in communication with, the network 1204. The functionality of the data storage 1210 also can be provided by one or more server computers configured to host data for the computing environment 1202. The data storage 1210 can include, host, or provide one or more real or virtual datastores 1226A-1226N (hereinafter referred to collectively and/or generically as “datastores 1226”). The datastores 1226 are configured to host data used or created by the application servers 1208 and/or other data. Although not illustrated in FIG. 12, the datastores 1226 also can host or store web add-ins, templates, documents, entitlements, user accounts, developer accounts, and the like.

The computing environment 1202 can communicate with, or be accessed by, the network interfaces 1212. The network interfaces 1212 can include various types of network hardware and software for supporting communications between two or more computing devices including, but not limited to, the clients 1206 and the application servers 1208. It should be appreciated that the network interfaces 1212 also may be utilized to connect to other types of networks and/or computer systems.

It should be understood that the distributed computing environment 1200 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1200 provides the software functionality described herein as a service to the clients 1206. It should be understood that the clients 1206 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 1200 to utilize the functionality described herein for distributing web-based software application extensions within documents, among other aspects.

Turning now to FIG. 13, an illustrative computing device architecture 1300 for a computing device that is capable of executing various software components described herein for distributing web-based software application extensions within documents, among other aspects. In some embodiments, the user device A 102A, the user device B 102B, the user device N 102N, and/or the web add-in and marketplace server computer 106 uses the architecture 1300 or some variation thereof. The computing device architecture 1300 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. The computing device architecture 1300 is applicable to any of the clients 1306 shown in FIG. 12. Moreover, aspects of the computing device architecture 1300 may be applicable to traditional desktop computers, portable computers (e.g., laptops, notebooks, ultra-portables, and netbooks), server computers, and other computer systems, such as described herein with reference to FIG. 11. For example, the single touch and multi-touch aspects disclosed herein below may be applied to desktop computers that utilize a touchscreen or some other touch-enabled device, such as a touch-enabled track pad or touch-enabled mouse.

The computing device architecture 1300 illustrated in FIG. 13 includes a processor 1302, memory components 1304, network connectivity components 1306, sensor components 1308, input/output components 1310, and power components 1312. In the illustrated embodiment, the processor 1302 is in communication with the memory components 1304, the network connectivity components 1306, the sensor components 1308, the input/output (“I/O”) components 1310, and the power components 1312. Although no connections are shown between the individuals components illustrated in FIG. 13, the components can interact to carry out device functions. In some embodiments, the components are arranged so as to communicate via one or more busses (not shown).

The processor 1302 includes a central processing unit (“CPU”) configured to process data, execute computer-executable instructions of one or more application programs, and communicate with other components of the computing device architecture 1300 in order to perform various functionality described herein. The processor 1302 may be utilized to execute aspects of the software components presented herein and, particularly, those that utilize, at least in part, a touch-enabled input.

In some embodiments, the processor 1302 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some embodiments, the processor 1302 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 1302 is, or is included in, a system-on-chip (“SoC”) along with one or more of the other components described herein below. For example, the SoC may include the processor 1302, a GPU, one or more of the network connectivity components 1306, and one or more of the sensor components 1308. In some embodiments, the processor 1302 is fabricated, in part, utilizing a package-on-package (“PoP”) integrated circuit packaging technique. The processor 1302 may be a single core or multi-core processor.

The processor 1302 may be created in accordance with an ARM architecture, available for license from ARM HOLDINGS of Cambridge, United Kingdom. Alternatively, the processor 1302 may be created in accordance with an x86 architecture, such as is available from INTEL CORPORATION of Mountain View, Calif. and others. In some embodiments, the processor 1302 is a SNAPDRAGON SoC, available from QUALCOMM of San Diego, Calif.; a TEGRA SoC, available from NVIDIA of Santa Clara, Calif.; a HUMMINGBIRD SoC, available from SAMSUNG of Seoul, South Korea; an Open Multimedia Application Platform (“OMAP”) SoC, available from TEXAS INSTRUMENTS of Dallas, Tex.; a customized version of any of the above SoCs; or a proprietary SoC.

The memory components 1304 include a random access memory (“RAM”) 1314, a read-only memory (“ROM”) 1316, an integrated storage memory (“integrated storage”) 1318, and a removable storage memory (“removable storage”) 1320. In some embodiments, the RAM 1314 or a portion thereof, the ROM 1316 or a portion thereof, and/or some combination the RAM 1314 and the ROM 1316 is integrated in the processor 1302. In some embodiments, the ROM 1316 is configured to store a firmware, an operating system or a portion thereof (e.g., operating system kernel), and/or a bootloader to load an operating system kernel from the integrated storage 1318 and/or the removable storage 1320.

The integrated storage 1318 can include a solid-state memory, a hard disk, or a combination of solid-state memory and a hard disk. The integrated storage 1318 may be soldered or otherwise connected to a logic board upon which the processor 1302 and other components described herein also may be connected. As such, the integrated storage 1318 is integrated in the computing device. The integrated storage 1318 is configured to store an operating system or portions thereof, application programs, data, and other software components described herein.

The removable storage 1320 can include a solid-state memory, a hard disk, or a combination of solid-state memory and a hard disk. In some embodiments, the removable storage 1320 is provided in lieu of the integrated storage 1318. In other embodiments, the removable storage 1320 is provided as additional optional storage. In some embodiments, the removable storage 1320 is logically combined with the integrated storage 1318 such that the total available storage is made available as a total combined storage capacity. In some embodiments, the total combined capacity of the integrated storage 1318 and the removable storage 1320 is shown to a user instead of separate storage capacities for the integrated storage 1318 and the removable storage 1320.

The removable storage 1320 is configured to be inserted into a removable storage memory slot (not shown) or other mechanism by which the removable storage 1320 is inserted and secured to facilitate a connection over which the removable storage 1320 can communicate with other components of the computing device, such as the processor 1302. The removable storage 1320 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1304 can store an operating system. According to various embodiments, the operating system includes, but is not limited to, SYMBIAN OS from SYMBIAN LIMITED, WINDOWS mobile OS from Microsoft Corporation of Redmond, Wash., WINDOWS phone OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1306 include a wireless wide area network component (“WWAN component”) 1322, a wireless local area network component (“WLAN component”) 1324, and a wireless personal area network component (“WPAN component”) 1326. The network connectivity components 1306 facilitate communications to and from the network 104 or another network, which may be a WWAN, a WLAN, or a WPAN. Although only the network 104 is illustrated, the network connectivity components 1306 may facilitate simultaneous communication with multiple networks. For example, the network connectivity components 1306 may facilitate simultaneous communications with multiple networks via one or more of a WWAN, a WLAN, or a WPAN.

The network 104 may be or may include a WWAN, such as a mobile telecommunications network utilizing one or more mobile telecommunications technologies to provide voice and/or data services to a computing device utilizing the computing device architecture 1300 via the WWAN component 1322. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 104 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 104 may be configured to provide voice and/or data communications with any combination of the above technologies. The network 104 may be configured to or adapted to provide voice and/or data communications in accordance with future generation technologies.

In some embodiments, the WWAN component 1322 is configured to provide dual-multi-mode connectivity to the network 104. For example, the WWAN component 1322 may be configured to provide connectivity to the network 104, wherein the network 104 provides service via GSM and UMTS technologies, or via some other combination of technologies. Alternatively, multiple WWAN components 1322 may be utilized to perform such functionality, and/or provide additional functionality to support other non-compatible technologies (i.e., incapable of being supported by a single WWAN component). The WWAN component 1322 may facilitate similar connectivity to multiple networks (e.g., a UMTS network and an LTE network).

The network 104 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 1324 is configured to connect to the network 104 via the WI-FI access points. Such connections may be secured via various encryption technologies including, but not limited, WI-FI Protected Access (“WPA”), WPA2, Wired Equivalent Privacy (“WEP”), and the like.

The network 104 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 1326 is configured to facilitate communications with other devices, such as peripherals, computers, or other computing devices via the WPAN.

The sensor components 1308 include a magnetometer 1328, an ambient light sensor 1330, a proximity sensor 1332, an accelerometer 1334, a gyroscope 1336, and a Global Positioning System sensor (“GPS sensor”) 1338. It is contemplated that other sensors, such as, but not limited to, temperature sensors or shock detection sensors, also may be incorporated in the computing device architecture 1300.

The magnetometer 1328 is configured to measure the strength and direction of a magnetic field. In some embodiments the magnetometer 1328 provides measurements to a compass application program stored within one of the memory components 1304 in order to provide a user with accurate directions in a frame of reference including the cardinal directions, north, south, east, and west. Similar measurements may be provided to a navigation application program that includes a compass component. Other uses of measurements obtained by the magnetometer 1328 are contemplated.

The ambient light sensor 1330 is configured to measure ambient light. In some embodiments, the ambient light sensor 1330 provides measurements to an application program stored within one the memory components 1304 in order to automatically adjust the brightness of a display (described below) to compensate for low-light and high-light environments. Other uses of measurements obtained by the ambient light sensor 1330 are contemplated.

The proximity sensor 1332 is configured to detect the presence of an object or thing in proximity to the computing device without direct contact. In some embodiments, the proximity sensor 1332 detects the presence of a user's body (e.g., the user's face) and provides this information to an application program stored within one of the memory components 1304 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1332 are contemplated.

The accelerometer 1334 is configured to measure proper acceleration. In some embodiments, output from the accelerometer 1334 is used by an application program as an input mechanism to control some functionality of the application program. For example, the application program may be a video game in which a character, a portion thereof, or an object is moved or otherwise manipulated in response to input received via the accelerometer 1334. In some embodiments, output from the accelerometer 1334 is provided to an application program for use in switching between landscape and portrait modes, calculating coordinate acceleration, or detecting a fall. Other uses of the accelerometer 1334 are contemplated.

The gyroscope 1336 is configured to measure and maintain orientation. In some embodiments, output from the gyroscope 1336 is used by an application program as an input mechanism to control some functionality of the application program. For example, the gyroscope 1336 can be used for accurate recognition of movement within a 3D environment of a video game application or some other application. In some embodiments, an application program utilizes output from the gyroscope 1336 and the accelerometer 1334 to enhance control of some functionality of the application program. Other uses of the gyroscope 1336 are contemplated.

The GPS sensor 1338 is configured to receive signals from GPS satellites for use in calculating a location. The location calculated by the GPS sensor 1338 may be used by any application program that requires or benefits from location information. For example, the location calculated by the GPS sensor 1338 may be used with a navigation application program to provide directions from the location to a destination or directions from the destination to the location. Moreover, the GPS sensor 1338 may be used to provide location information to an external location-based service, such as E911 service. The GPS sensor 1338 may obtain location information generated via WI-FI, WIMAX, and/or cellular triangulation techniques utilizing one or more of the network connectivity components 1306 to aid the GPS sensor 1338 in obtaining a location fix. The GPS sensor 1338 may also be used in Assisted GPS (“A-GPS”) systems.

The I/O components 1310 include a display 1340, a touchscreen 1342, a data I/O interface component (“data I/O”) 1344, an audio I/O interface component (“audio I/O”) 1346, a video I/O interface component (“video I/O”) 1348, and a camera 1350. In some embodiments, the display 1340 and the touchscreen 1342 are combined. In some embodiments two or more of the data I/O component 1344, the audio I/O component 1346, and the video I/O component 1348 are combined. The I/O components 1310 may include discrete processors configured to support the various interface described below, or may include processing functionality built-in to the processor 1302.

The display 1340 is an output device configured to present information in a visual form. In particular, the display 1340 may present GUI elements, web add-in interfaces, text, images, video, notifications, virtual buttons, virtual keyboards, messaging data, Internet content, device status, time, date, calendar data, preferences, map information, location information, and any other information that is capable of being presented in a visual form. In some embodiments, the display 1340 is a liquid crystal display (“LCD”) utilizing any active or passive matrix technology and any backlighting technology (if used). In some embodiments, the display 1340 is an organic light emitting diode (“OLED”) display. Other display types are contemplated.

The touchscreen 1342 is an input device configured to detect the presence and location of a touch. The touchscreen 1342 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 1342 is incorporated on top of the display 1340 as a transparent layer to enable a user to use one or more touches to interact with objects or other information presented on the display 1340. In other embodiments, the touchscreen 1342 is a touch pad incorporated on a surface of the computing device that does not include the display 1340. For example, the computing device may have a touchscreen incorporated on top of the display 1340 and a touch pad on a surface opposite the display 1340.

In some embodiments, the touchscreen 1342 is a single-touch touchscreen. In other embodiments, the touchscreen 1342 is a multi-touch touchscreen. In some embodiments, the touchscreen 1342 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1342. As such, a developer may create gestures that are specific to a particular application program and/or to a specific web add-in.

In some embodiments, the touchscreen 1342 supports a tap gesture in which a user taps the touchscreen 1342 once on an item presented on the display 1340. The tap gesture may be used for various reasons including, but not limited to, opening or launching whatever the user taps. In some embodiments, the touchscreen 1342 supports a double tap gesture in which a user taps the touchscreen 1342 twice on an item presented on the display 1340. The double tap gesture may be used for various reasons including, but not limited to, zooming in or zooming out in stages. In some embodiments, the touchscreen 1342 supports a tap and hold gesture in which a user taps the touchscreen 1342 and maintains contact for at least a pre-defined time. The tap and hold gesture may be used for various reasons including, but not limited to, opening a context-specific menu.

In some embodiments, the touchscreen 1342 supports a pan gesture in which a user places a finger on the touchscreen 1342 and maintains contact with the touchscreen 1342 while moving the finger on the touchscreen 1342. The pan gesture may be used for various reasons including, but not limited to, moving through screens, images, or menus at a controlled rate. Multiple finger pan gestures are also contemplated. In some embodiments, the touchscreen 1342 supports a flick gesture in which a user swipes a finger in the direction the user wants the screen to move. The flick gesture may be used for various reasons including, but not limited to, scrolling horizontally or vertically through menus or pages. In some embodiments, the touchscreen 1342 supports a pinch and stretch gesture in which a user makes a pinching motion with two fingers (e.g., thumb and forefinger) on the touchscreen 1342 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1342. As such, the above gestures should be understood as being illustrative and should not be construed as being limiting in any way.

The data I/O interface component 1344 is configured to facilitate input of data to the computing device and output of data from the computing device. In some embodiments, the data I/O interface component 1344 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 1346 is configured to provide audio input and/or output capabilities to the computing device. In some embodiments, the audio I/O interface component 1344 includes a microphone configured to collect audio signals. In some embodiments, the audio I/O interface component 1344 includes a headphone jack configured to provide connectivity for headphones or other external speakers. In some embodiments, the audio I/O interface component 1346 includes a speaker for the output of audio signals. In some embodiments, the audio I/O interface component 1344 includes an optical audio cable out.

The video I/O interface component 1348 is configured to provide video input and/or output capabilities to the computing device. In some embodiments, the video I/O interface component 1348 includes a video connector configured to receive video as input from another device (e.g., a video media player such as a DVD or BLURAY player) or send video as output to another device (e.g., a monitor, a television, or some other external display). In some embodiments, the video I/O interface component 1348 includes a High-Definition Multimedia Interface (“HDMI”), mini-HDMI, micro-HDMI, DisplayPort, or proprietary connector to input/output video content. In some embodiments, the video I/O interface component 1348 or portions thereof is combined with the audio I/O interface component 1346 or portions thereof.

The camera 1350 can be configured to capture still images and/or video. The camera 1350 may utilize a charge coupled device (“CCD”) or a complementary metal oxide semiconductor (“CMOS”) image sensor to capture images. In some embodiments, the camera 1350 includes a flash to aid in taking pictures in low-light environments. Settings for the camera 1350 may be implemented as hardware or software buttons.

Although not illustrated, one or more hardware buttons may also be included in the computing device architecture 1300. The hardware buttons may be used for controlling some operational aspect of the computing device. The hardware buttons may be dedicated buttons or multi-use buttons. The hardware buttons may be mechanical or sensor-based.

The illustrated power components 1312 include one or more batteries 1352, which can be connected to a battery gauge 1354. The batteries 1352 may be rechargeable or disposable. Rechargeable battery types include, but are not limited to, lithium polymer, lithium ion, nickel cadmium, and nickel metal hydride. Each of the batteries 1352 may be made of one or more cells.

The battery gauge 1354 can be configured to measure battery parameters such as current, voltage, and temperature. In some embodiments, the battery gauge 1354 is configured to measure the effect of a battery's discharge rate, temperature, age and other factors to predict remaining life within a certain percentage of error. In some embodiments, the battery gauge 1354 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1312 may also include a power connector, which may be combined with one or more of the aforementioned I/O components 1310. The power components 1312 may interface with an external power system or charging equipment via a power I/O component 1342.

Based on the foregoing, it should be appreciated that technologies for distributing web-based software application extensions within documents have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for distributing a software application extension with a document, the computer-implemented method comprising performing computer-implemented operations for:
acquiring the software application extension;
creating a document containing the software application extension in a certain state, the certain state being identified in the document as configuration data;
saving the document containing the software application extension and the configuration data; and
distributing the document to one or more computer systems.

2. The computer-implemented method of claim 1, wherein the software application extension is a web-based software application extension.

3. The computer-implemented method of claim 2, wherein the web-based software application extension comprises a manifest file describing a location of a web add-in server or a reference to the manifest file, and the web-based software application extension is a content web add-in configured to enable a web page or a portion thereof retrieved from the web add-in server to become part of the document or another document as embedded content.

4. The computer-implemented method of claim 3, wherein the embedded content is presented inline with content of the document or the other document, wrapped with content of the document or the other document, over content of the document or the other document, or behind content of the document or the other document.

5. The computer-implemented method of claim 2, wherein the web-based software application extension comprises a manifest file describing a location of a web add-in server or a reference to the manifest file, and the web-based software application extension is an out-of-document web add-in configured to enable a web page or a portion thereof to accessible outside of the document, the out-of-document web add-in comprising a task pane web add-in, a floating web add-in, a ribbon web add-in, a menu web add-in, a toolbar add-in, a status bar add-in, a popup menu add-in, or a separate application.

6. The computer-implemented method of claim 1, further comprising saving the document thereby creating a snapshot of the software application extension that permits the software application extension to be viewed at one or more of the computer systems that are configured with a viewer application that facilitates viewing of software application extensions but not editing of software application extension, and wherein distributing the document to the one or more computer systems comprises distributing the document to the one or more computer systems, one or more of which is operated by an unlicensed user that does not have an entitlement to use the software application extension.

7. The computer-implemented method of claim 6, further comprising facilitating the unlicensed user to acquire a trial entitlement, a purchase entitlement, or a free entitlement for the software application to utilize the software application.

8. The computer-implemented method of claim 1, wherein receiving the software application comprises receiving a web add-in within another document from a computer system, and further comprising:
determining if a user has an entitlement for the web add-in;
in response to determining that the user has an entitlement for the web add-in, providing the web add-in for use in accordance with the entitlement;
in response to determining that the user does not have an entitlement for the web add-in, presenting options for the user to try, buy, or receive for free the web add-in; and
in response to receiving a selection of one of the options, sending an entitlement request to a web add-in and marketplace server computer, receiving an entitlement response from the web add-in and marketplace server computer indicating entitlement terms for an entitlement for the web add-in in accordance with the selected option, and providing the web add-in for use in accordance with the entitlement.

9. A computer-implemented method for distributing a web add-in with a document, the computer-implemented method comprising performing computer-implemented operations for:
acquiring a web add-in;
creating a document;
inserting the web add-in into the document;
saving the document containing
a manifest file or a reference to the manifest file, the manifest file describing a location of a web add-in server, which is configured to provide web content for the web add-in,
a static snapshot of the web add-in that permits the web add-in to be viewed at user devices that are configured with a viewer application that facilitates viewing of web add-ins but not editing of web add-ins, and
configuration data identifying a certain state of the web add-in in the document; and
distributing the document containing the manifest file, the configuration data, and the static snapshot to one or more user devices.

10. The computer-implemented method of claim 9, wherein receiving the web add-in comprises one of the following:
acquiring the web add-in from a marketplace server computer;
downloading web content from a web site or web service for the web add-in;
receiving the web add-in from another user device; or
receiving the web add-in in another document.

11. The computer-implemented method of claim 9, wherein distributing the web add-in to the one or more user devices comprises distributing the web add-in to the one or more user devices, at least one of which is operated by an unlicensed user.

12. The computer-implemented method of claim 11, further comprising facilitating the unlicensed user to acquire a trial entitlement, a purchase entitlement, or a free entitlement for the web add-in to utilize the web add-in.

13. The computer-implemented method of claim 9, further comprising acquiring an entitlement for the web add-in, the entitlement comprising a trial entitlement, a purchase entitlement, or a free entitlement.

14. The computer-implemented method of claim 9, wherein creating the document comprises creating a document based upon a document template, the document template containing the web add-in, and inserting the web add-in into the document comprises using the web add-in contained in the document template.

15. The computer-implemented method of claim 14, further comprising modifying the web add-in to create a modified web add-in, and wherein inserting the web add-in into the document comprises inserting the modified web add-in into the document.

16. The computer-implemented method of claim 13, wherein the entitlement is a trial entitlement comprising one or more restrictions, each of the one or more restrictions comprising a time restriction, a use restriction, or a functionality restriction.

17. The computer-implemented method of claim 9, further comprising:
determining if a user has an entitlement for the web add-in;
in response to determining that the user has an entitlement for the web add-in, providing the web add-in for use in accordance with the entitlement;
in response to determining that the user does not have an entitlement for the web add-in, presenting options for the user to try or buy the web add-in; and
in response to receiving a selection of one of the options, sending an entitlement request to a web add-in and marketplace server computer, receiving an entitlement response from the web add-in and marketplace server computer indicating entitlement terms for an entitlement for the web add-in in accordance with the selected option, and providing the web add-in for use in accordance with the entitlement.

18. A computer storage medium having computer readable instructions stored thereupon that, when executed by a computer, cause the computer to:
receive a web add-in distributed by a user device;
determine if a user has an entitlement for the web add-in;
in response to determining that the user has an entitlement for the web add-in, provide the web add-in for use in accordance with the entitlement;
in response to determining that the user does not have an entitlement for the web add-in, present options for the user to try or buy the web add-in;
in response to receiving a selection of one of the options, send an entitlement request to a web add-in and marketplace server computer, receive an entitlement response from the web add-in and marketplace server computer indicating entitlement terms for an entitlement for the web add-in in accordance with the selected option, and provide the web add-in for use in accordance with the entitlement;
create a document;
insert the web add-in into the document;
save the document containing the web add-in; and
distribute the document containing the web add-in to one or more other user devices.

19. The computer storage medium of claim 18, wherein the instructions that, when executed by the computer, cause the computer to insert the web add-in into the document comprise instructions that, when executed by the computer, cause the computer to embed a content web add-in into the document.

20. The computer storage medium of claim 18, wherein the instructions that, when executed by the computer, cause the computer to insert the web add-in into the document comprise instructions that, when executed by the computer, cause the computer to attach a task pane add-in to the document so that an application configured to open the document recognizes the task pane and inserts the task pane into a user interface of the application.
